(19) United States
(12) Patent Application Publication
(10) Pub. No.: US 2017/0150686 A1
(43) Pub. Date: Jun. 1, 2017

(54) CONTAINER FOR SUPPLYING PLANT ROOTS WITH NUTRIENT SOLUTION WITHOUT THE USE OF SOIL

(71) Applicant: Clemens Erbacher, Markt Nordheim (DE)

(72) Inventor: Clemens Erbacher, Markt Nordheim (DE)

(21) Appl. No.: 15/113,491

(22) PCT Filed: Jan. 23, 2015
(86) PCT No.: PCT/EP2015/000132

§ 371 Date: Nov. 29, 2016

(30) Foreign Application Priority Data
Jan. 24, 2014 (DE) 10 2014 000 942.4
Jan. 15, 2015 (DE) 10 2015 000 456.5

(51) Int. Cl. A01G 31/02; B05B 17/00; B65D 43/16

(52) U.S. Cl. CPC A01G 31/02; B65D 43/161; B05B 17/00

(57) ABSTRACT

A container (1) for supplying plant roots with nutrient solution without the use of soil has a basic shape which is selected from the group of basic shapes comprising cubes, cuboids, ellipsoids, spheres, rings, pyramids, cones, prisms and cylinders as well as combinations and parts of these shapes and asymmetrical shapes. The container (1) has an interior, which is provided for accommodating the plant roots, and a separating slot (8), which is arranged at a boundary of the container interior and is designed to subject at least one plant to clamping-in action, while at the same time allowing said plant to grow.

### FIELD OF THE INVENTION

The invention relates to a container, suitable for supplying plant roots with nutrient solution in the absence of soil, that is to say, a hydroponic or aeroponic container.

### BACKGROUND OF THE INVENTION

A hydroponic container is known, for example, from WO 2011/016856 A1. It relates in this case to a vertical, column container, the front of which has a slot through which the plants can emerge.

DE 10 2008 030 26 B4 discloses an aeroponic root spraying pot, in which a root grid system is located which is composed of a plurality of individual components.

### OBJECT OF THE INVENTION

It is the object of the invention to further develop a hydroponic or aeroponic system in comparison to the said state of the art, in particular with regard to a wide range of applications and user friendliness, as well as favourable growth conditions for a great variety of plants.

### DESCRIPTION OF THE INVENTION

The present invention is attained according to the invention by a container having the features of claim 1, as well as by a process for supplying plant roots with nutrient solution in the absence of soil according to claim 30. Advantages and embodiments elucidated hereinafter in connection with the process shall apply mutatis mutandis to the device as well, that is to say the hydroponic or aeroponic container, and vice versa.

The container of any geometry has an interior space, suitable to accommodate plant material. In particular, a root system may be located in the interior of the container. If, in addition, a substrate is provided in the interior of the container, for example, in the form of granulate, where supplying the roots with nutrients is effected by means of a nutrient solution, including in sprayed form, this is referred to as hydroponics. If, on the other hand, only an aerosol is provided for supplying the roots with water and nutrients, such is referred to as aeroponics. The interior of the container is in both cases bounded by at least one separating slot, which clamps at least one plant or part of the plant, while at the same time allowing said plant to grow. The clamping effect is in this case brought about in a manner which, on the one hand, affords mechanical support, without, on the other hand, resulting in damaging the plant. Clamping is brought about in that the plant or the plant part is subjected to mechanical pressure on at least two sides, in which context such pressure, as well as the locations where the pressure acts on the plant or the plant part, may vary widely according to the type of plant and dimension.

According to a possible embodiment, the container includes at least one column body, under which column body or column bodies a basic container is accommodated. The cross-section of the basic container—viewed from above, that is to say in the longitudinal direction of the column body—is larger than the cross-section of the single column body or of each individual one of the column bodies. Each column is connected to the basic container in a detachable manner. A cover may be provided on the basic container, on which it is optionally possible to walk. In an advantageous embodiment, a plurality of separating slots, through which plants may grow out in the direction of the interstices between the column bodies, is provided on the surface of each column body which may be open or closed on its upper side.

According to a further possible embodiment, a basic container body constituting the main component of the container is formed as a structural element suitable to establish a wall, consisting, in particular, of artificial stone. Like in all other embodiments, the container designed as structural element is likewise sufficiently water-resistant for its use as hydroponic or aeroponic container. The mechanical stability of the structural element may be comparable to the stability of conventional masonry bricks. The structural element may be made from materials such as concrete, expanded concrete, metal, for example steel or light metal, or a composite of different materials. In all cases, a wall thickness of the basic container body may decrease towards a coverable container aperture. The basic container body may also be designed as the edge- or corner element of a wall. On the lower edge of the front of the structural element which can be closed by a cover, an edge strip may be present which ensures that a specific maximum amount of liquid can accumulate in the container. A plurality of similar or different structural elements may be adapted to interconnect, for example by tongue and groove connections or other form-fitting connections.

Instead of for establishing a wall or cladding a wall, for example in the form of a tile, the basic container body may also be designed as a roof tile or shingle suitable to cover the roof of a building. For the manufacture of such a roof tile or shingle, which permits roof greening, all aforesaid materials are considered acceptable as well, including fired clay. The roof tile or shingle, like the structural element, may include a feed and a discharge system for feeding and discharging liquids, in particular water, making available a liquid-conducting connection between structural elements or, respectively, roof tiles or shingles in close contact with one another. The container designed as wall element or roof element may further include power- or data lines, connected, in particular, to sensors and/or actuators integrated in the container.

According to a further embodiment of the container, only one single plant, in particular a tree, is accommodated therein. In this case the container includes a multi-part, adjustable support device for the plant, fixed to a basic container body. By contrast, the support device may also be fitted to an object outside the container. This applies also to modified embodiments, wherein a plurality of plants, in particular trees, are supported individually in the container.

The assembly of several, identical or different containers does not in all cases require that the individual containers, such as, for example, a masonry brick, are load-bearing, that is to say, able to receive a further, in particular, multiple load in addition to their own weight. Rather, support structures are feasible in which a plurality of non-load-bearing basic container bodies are provided. The basic container bodies are in this context supported by a support structure, which can be connected to further load-bearing structural elements, thus forming the load-bearing structure. At least one part of the support structure can be attributed to the container.

In a particularly simple design, the hydroponic or aeroponic container is configured as a pipe, in which a longitudinal slot is present. The longitudinal slot may be straight or may present a different configuration, for example, undulated or serrated. Additional elements, such as clamping elements, may be provided in order to keep the longitudinal slot in an intended position, thereby lending support to plants. When growing the plants, the pipe may be in vertical or horizontal position or in any intermediate position. The longitudinal slot may be covered by a single-part or multi-part cover, the said cover being able to also take on functions of a clamping or supporting element.

A hose, slit on top in longitudinal direction, can likewise be used as container. In this case as well, the slot is not necessarily straight. As a result of the roll-up facility, this embodiment is especially transport-friendly as well as storage- and assembly-friendly. The hose also lends itself to be moved on uneven surfaces. In general, the hose may be used in any desired position, even suspended, for hydroponic or aeroponic cultures.

In order to stabilise the container being in the form of a hose, an endoskeleton or an exoskeleton may be provided. A spiral which can be compressed to very compact dimensions for transport purposes is particularly suitable as an exoskeleton. In both types of design of the skeleton a feed line can be suspended therefrom, which supplies the plants growing out of the hose with nutrient solution. Embodiments are also feasible, wherein the feed line is fitted directly on the hose, for example by using eyelets or press-studs, or lying freely on the substrate. The inner diameter of the hose is preferably larger, several times over, compared with the outer diameter of the feed line through which the nutrient solution is fed, for example by spraying, dropping or atomising. For precise feeding, stub lines may be provided on the feed line, which terminate inside the hose.

Discharge of liquid from the hose may be provided for either over the entire length of the hose or only at individual, lower-lying locations of the hose. Apertures at the appropriate, lower-lying locations may be provided for this purpose in situ, that is to say after positioning the hose, for example by punching out and subsequent edge trimming.

A stable and gentle fixation of plants, protruding through the longitudinal slot, i.e. the separating slot of the hose, is attained in that a lip is provided on the separating slot, extending in the longitudinal direction of the hose, such lip being positioned orthogonally to the adjacent wall sections of the hose, that is to say, pointing in radial direction when viewed in cross-section.

Subdividing the lip into individual lip regions in spaced-apart relationship from one another continues to ensure the easy roll-up ability of the hose. The flat configuration of the lip regions also permits easy mounting on the separating slot of clamps holding together the lips, spacers or other ancillary components. This applies likewise to embodiments in which the container is not in hose form.

Instead of a skeleton, or in addition to a skeleton, a foam material may be inserted in the hose, which affords mechanical stability to the hose. Particularly low evaporation losses can be attained in that cover segments are positioned on the separating slot of the hose, which cover the separating slot at least in part.

A particularly stable embodiment of the container provides that a vegetation area is formed thereon, which is, in particular, represented by a lawn area. In this case, a grating or an arrangement of gratings is positioned on the interior of the container, in which context the separating slots may be formed by gratings, notably on the edges. A plurality of gratings may be superimposed. Sufficiently stable supporting elements are provided underneath the gratings. In addition to the grating or an arrangement of gratings composed of a plurality of gratings, a textile mat or a plurality of textile mats may be arranged on the container. The vegetation area may also be designed as an inclined surface or as a vertical surface—for example, for façade greening purposes.

In all cases where the hydroponic or aeroponic container is not installed into a surrounding structure, it may be advantageous to equip the container with a load sensor, which detects the overall weight of the container, including plants. Depending on the type of fixation of the container, the load sensor may, for example, be fitted in the floor region or on a hook, from which the container can be suspended. Particularly in cases where the orientation of the container is variable, it is advantageous for the container to have apertures which can be closed by plugs.

For covering a basic container body, covers are suitable which, depending on the design, may vary widely, and the same applies to the container. In a simple embodiment, the cover consists of a continuous, i.e. non-segmented surface, in which case at least one separating slot is formed between the basic container body and the cover. The cover may either be detachable from the basic container body or connected to the latter by a hinge.

Further developed embodiments of the container provide multi-part covers structured by individual cover segments. Individual cover segments may in this context either be provided in loose form or interconnected by hinges. In both cases, a frame is optionally present which encompasses the cover segments, the said frame being either rigid or—analogously to the movably interconnected cover segments—established by frame segments which are interconnected by hinges.

In the course of the plant growth or when replanting the container, it may be useful to change the spacing between the cover segments, in which context a tight closure of the interior of the container should remain ensured. This can be attained in that two cover segments are interconnected by a foldable foil strip. In regions where a separating slot must remain, that is to say either between two cover segments or between the cover and basic container, the separating slot can be closed to a large extent, for example by using a foam strip. If a variable length of the foam strip is of particular significance, notably in order to allow plant growth in a specific longitudinal direction of the container, individual sections of the foam strip may be interconnected by a foldable strip. The foldable strip, which in the folded state can be inserted into the slot at the cover surface, may either be made of material penetrable by roots or of material non-penetrable by roots.

Both in embodiments including foam strips and embodiments without foam strips a spacer or a number of spacers may be inserted into the separating slot. Such spacer may include a passage aperture connecting the interior of the container to the exterior space.

Particularly gentle conditions for plant growth are attained in that the separating slot is bounded by lips which are upright in relation to the adjacent container regions, that is to say tilted by 90°. The adjacent container regions may be regions of the cover or of the basic container body. The lips are particularly suited for fitting a foam strip as well as for fitting clamps. The lips, like the adjacent regions of the container or its cover, are preferably also composed of a planar material, the wall thickness of the lip not being greater than the wall thickness of the adjacent container or cover region.

In all geometric configurations of the container, water-feed elements may be provided in the interior of the container. Such water-feed elements are also effective in cases, in which the nutrient solution is passed into the interior of the container in the form of an aerosol. The water-feed elements may be liquid-tight or partially permeable. A partially permeable configuration is, in particular, considered useful for embodiments which provide a supply of nutrient solution in the form of a liquid flow. The water-feed elements may either be permanently installed in the container, in particular form an integral part of the container, or may be adapted to be removed from the container. A plurality of water-feed elements, arranged in series, are, for example, fitted in alternating fashion to opposing container walls.

In some cases it may be sufficient if merely the supply of nutrient solution is brought about in a defined manner, while the discharge of liquid takes place exclusively in a non-defined manner, for example by evaporation or via the plants. In contrast thereto, numerous embodiments of the container do, however, provide both a defined supply as well as a defined discharge from the container. The discharge duct is in this case not necessarily positioned at the lowest point of the container. Rather, the discharge duct may also be provided at a higher location in order to attain the formation of a sump inside the container. In the case of supplying the container with liquids, the introduction of the nutrient solution is mostly performed from above, above the roots. In aeroponic embodiments, the nutrient solution may be fed to the container as an aerosol from above, from the side or from below. The nutrient solution is, for example, supplied to the container from a basic container, provided, in particular, underneath the container, or from any other source via a feed duct.

In addition to the separating slots, the container may include further apertures, which are, however, not provided as apertures for plants, but as other apertures, for example, inspection apertures or harvesting apertures. In order to keep such an aperture closed for the most part, it may, for example, be formed by overlapping foil sections.

The aeroponic and hydroponic container, apart from a water supply, may also include an energy supply, in particular, a power supply and/or compressed air supply. Depending on the application, either a connection to a supply grid or an autonomous supply system, in particular by means of a battery, may be provided.

Inside the container a very wide range of actuator elements may be provided, for example an automatically-actuated valve such as a magnetic valve, a pump, a mist generator, an atomiser, or an air-conditioning device. The air-conditioning device may be suited for heating and/or cooling of the container.

The sensors provided inside the container may be, for example, temperature sensors, humidity sensors, conductivity sensors and/or pH-sensors. Data recorded by such sensors are statistically evaluated through an advantageous process management in order to control the actuators provided inside the container based on such evaluation.

In what follows, working examples of the invention are elucidated in more detail by way of a drawing. There is shown in:

### BRIEF DESCRIPTION OF THE DRAWINGS

FIGS. 1 to 6 Various cuboid hydroponic containers,

FIGS. 7 to 10 Cuboid hydroponic containers including a multi-part cover,

FIGS. 11 to 15 Diverse cover embodiments of hydroponic containers, partially including the container,

FIG. 16 A cylindrical hydroponic container,

FIG. 17 A spherical hydroponic container,

FIG. 18 A hydroponic container, provided for a single tree,

FIGS. 19 and 20 Various hydroponic containers, each composed of a plurality of basic shapes;

FIGS. 21 to 25 Various hydroponic containers provided as structural elements,

FIGS. 26 to 28 Various hydroponic containers, designed as corner elements for use in a wall,

FIG. 29 A hydroponic container, designed as a roof tile;

FIGS. 30 and 31 Hydroponic containers providing lawn areas,

FIGS. 32 to 41 Details of hydroponic lawn-area containers,

FIGS. 42 to 47 Hose-like hydroponic containers;

FIG. 48 A hydroponic container adapted to be integrated into a load-bearing structure,

FIGS. 49 and 50 Details of nutrient supply systems of hydroponic containers,

FIGS. 51 to 57 Details of flexible, sealing cover designs on hydroponic containers.

### DETAILS DESCRIPTION OF THE DRAWINGS

Parts corresponding to one another or parts having the same effect, in principle, are in all cases denoted by the same reference numeral. For purposes of linguistic abbreviation, reference is made to “hydroponic containers”. With a very wide range of geometries, this may, in fact, refer to a hydroponic or an aeroponic container.

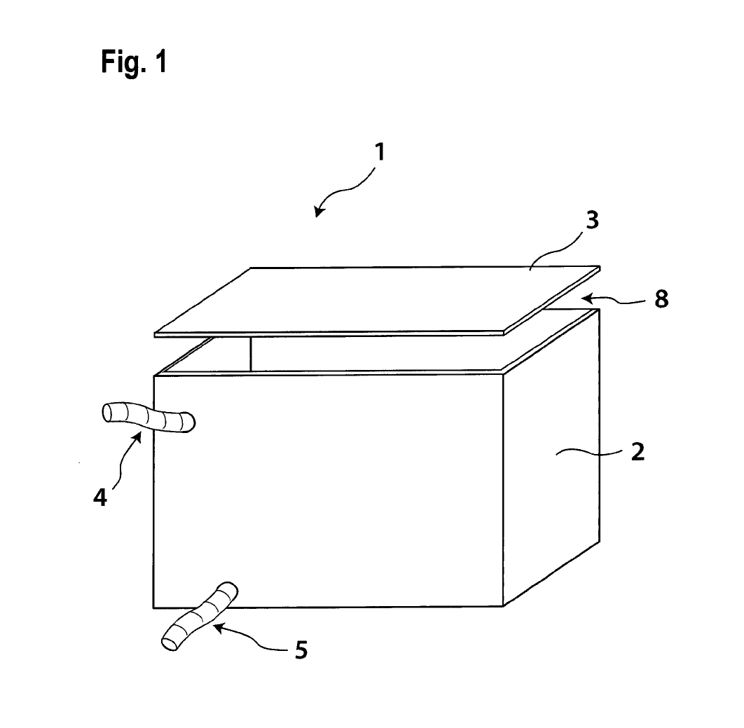

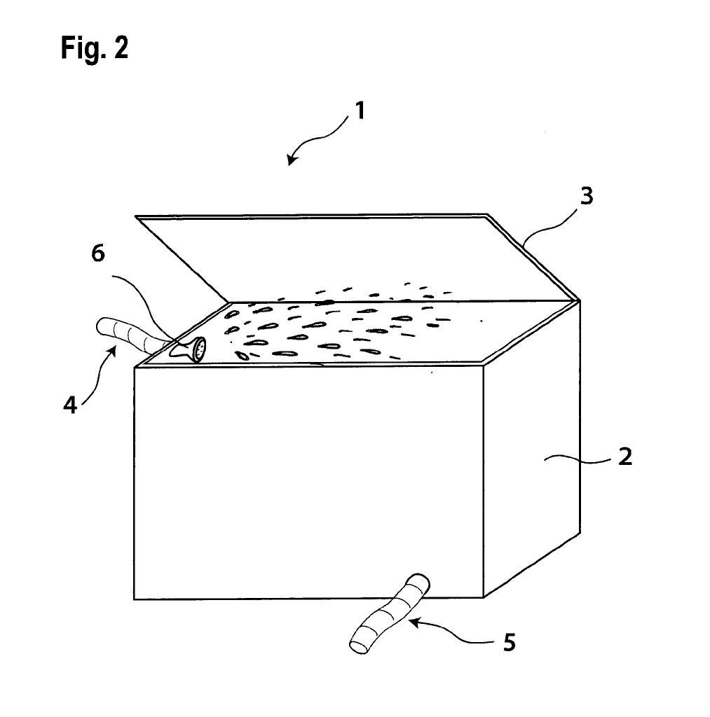

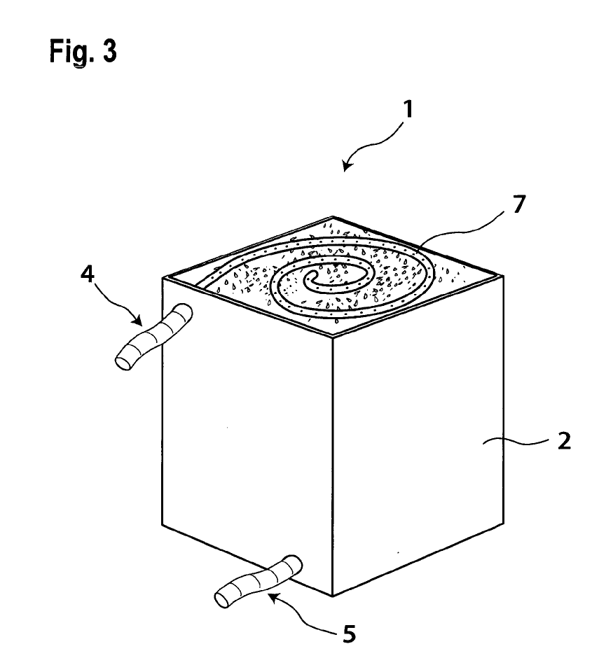

FIG. 1 shows a simple version of a container, denoted by reference numeral 1, for supplying plant roots with nutrient solution, that is to say, a hydroponic or aeroponic container. A basic cuboid container body is denoted by 2; a cover adapted to be placed thereon is denoted by 3. In addition, a feed duct 4, also referred to as feed line, and a discharge duct 5 are discernible. Various embodiments of the distribution of nutrient solution in the container 1 are apparent from FIGS. 2 and 3: In the embodiment according to FIG. 2, the nutrient solution is distributed in the interior of the container by a spray nozzle 6 and in the embodiment according to FIG. 3 by a spiral-shaped spray or drip coil 7.

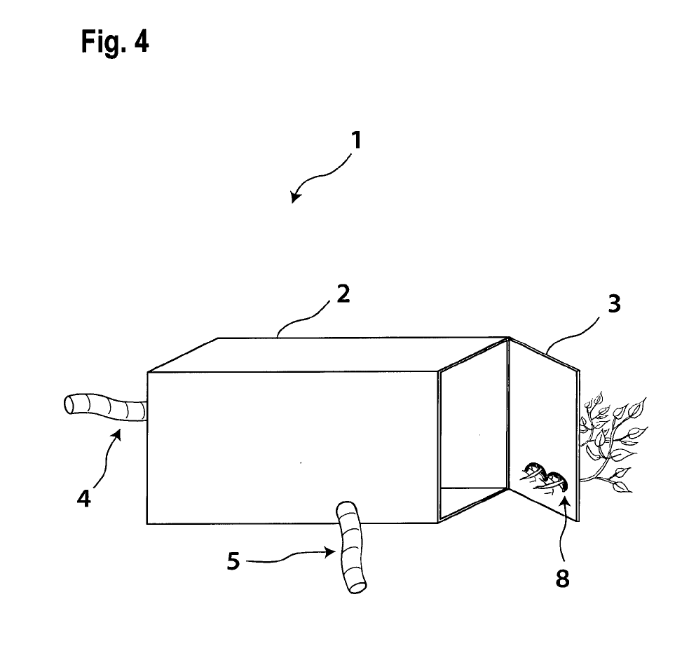

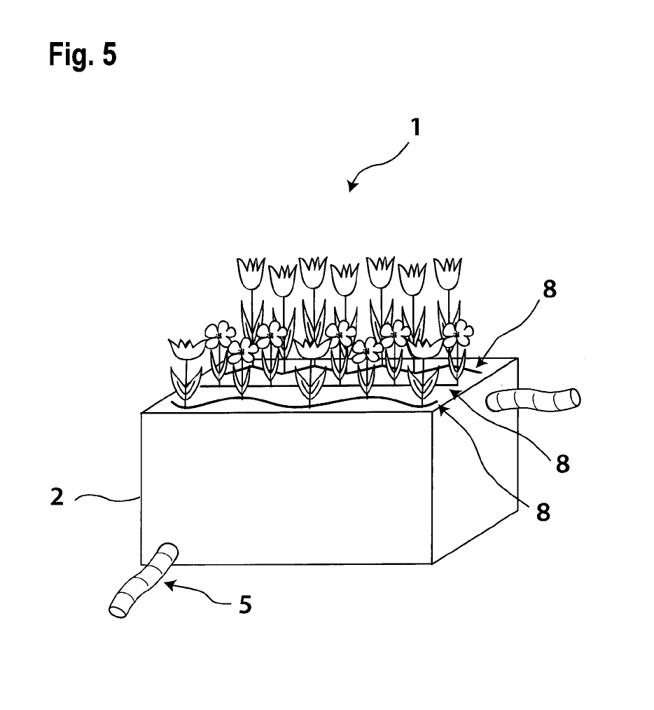

The aperture of the container 1 is not necessarily provided at the upper end of the basic container body 2, as is the case in the embodiments according to FIGS. 1 to 3. Rather, the aperture, as in the example according to FIG. 4, may also be situated on a lateral surface of the basic container body 2. In FIG. 4 a serpentine-shaped, that is to say sinusoidal separating slot 8 can further be seen within the cover 3. Plants, which grow through the separating slot 8, are at the same time stabilised by the latter. Further configurations of separating slots 8, namely a straight separating slot 8 and a serrated separated slot 8 can be seen in FIG. 5. Particularly configurations of separating slots 8 which are not straight offer the advantage that the container 1 can easily be bent open, which facilitates the introduction of objects, in particular of plant material into the interior of the container. In all types of the separating slot 8 the plants are clamped in by the latter in a gentle manner.

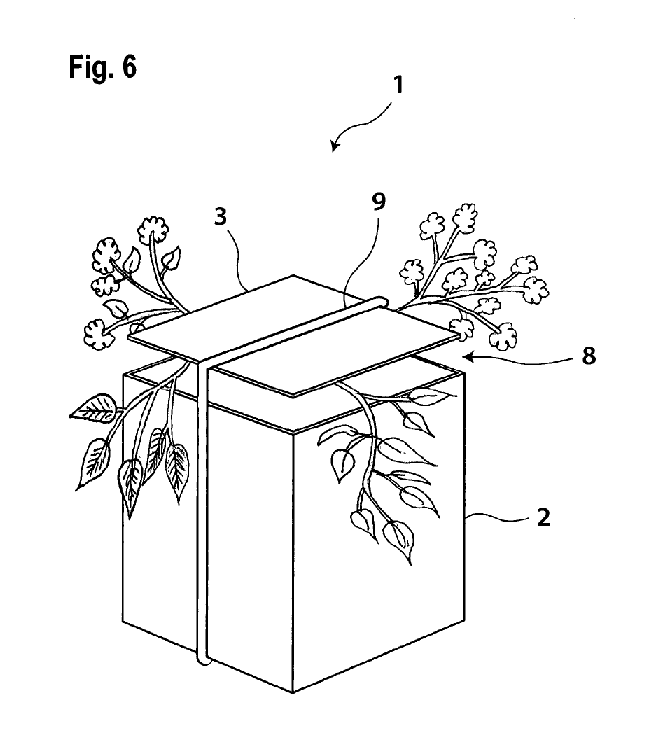

FIG. 6 shows a very simple version of the support device of the cover 3 on the basic container body 2, namely by means of a rubber band 9. Such fixation can likewise be attained with other container configurations. As the cover 3 in the embodiment according to FIG. 6 forms a closed surface, separating slots 8 are exclusively present between the cover 3 and the basic container body 2.

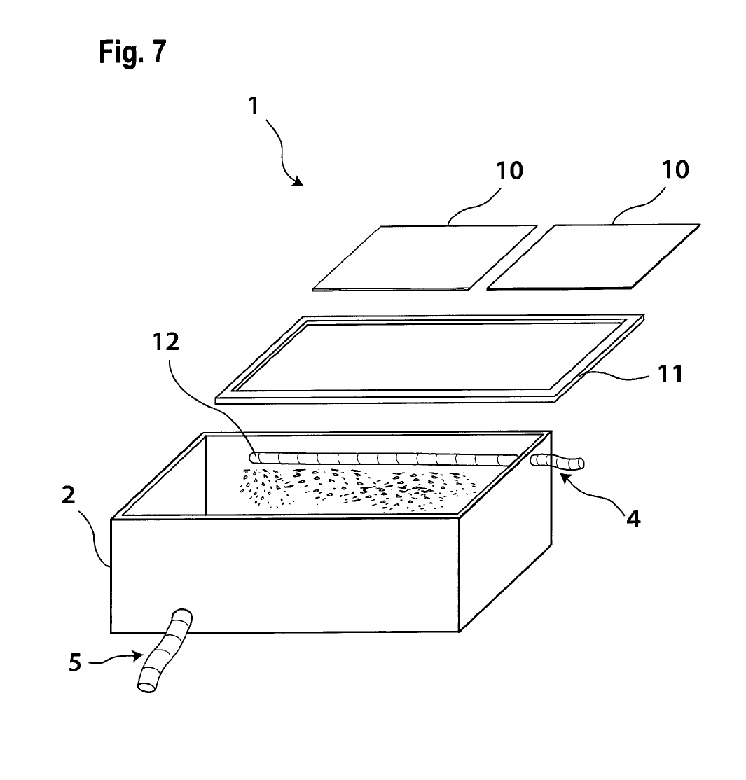

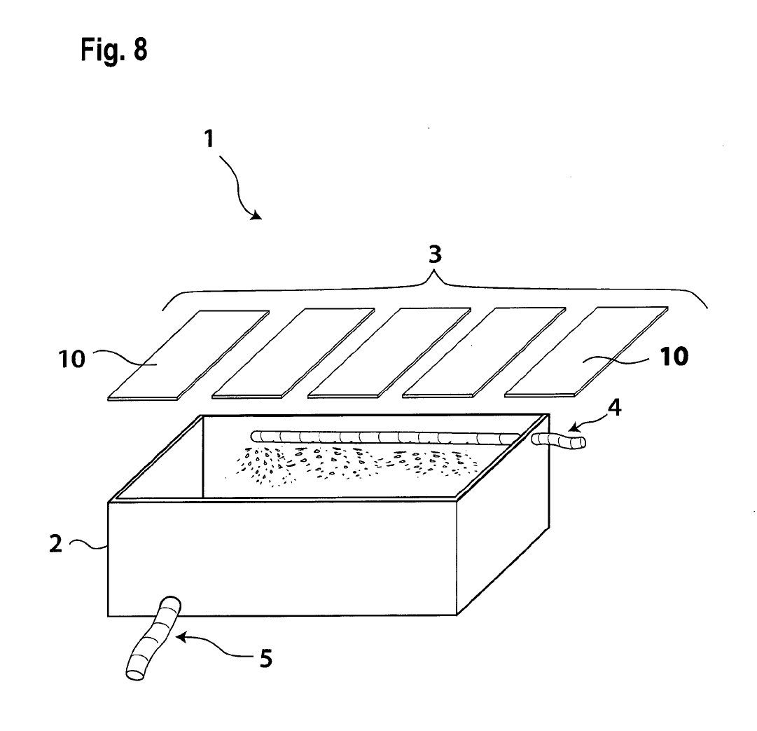

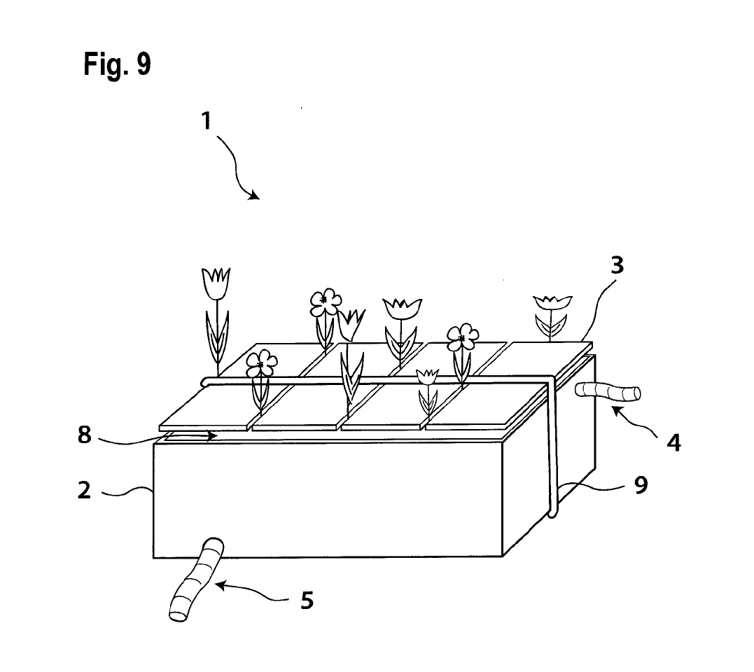

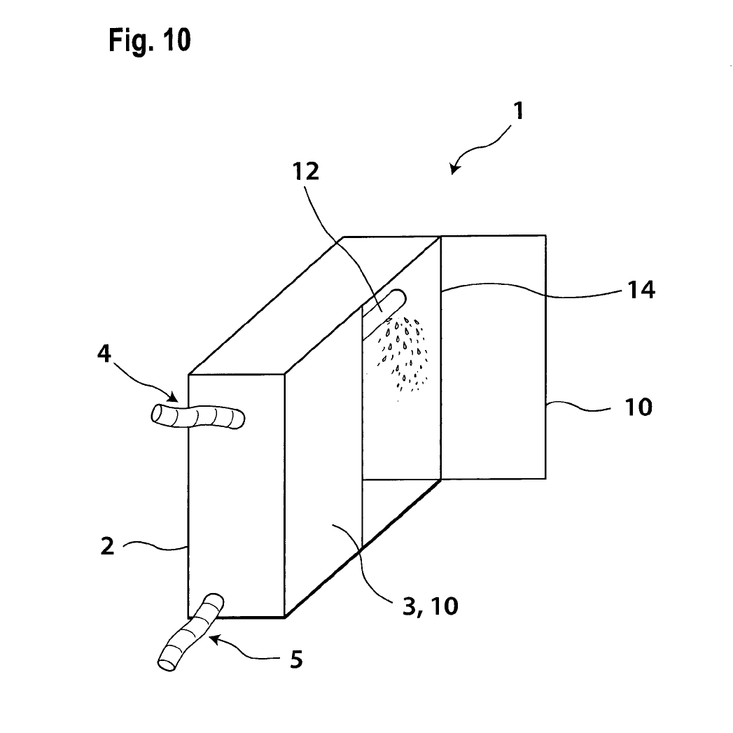

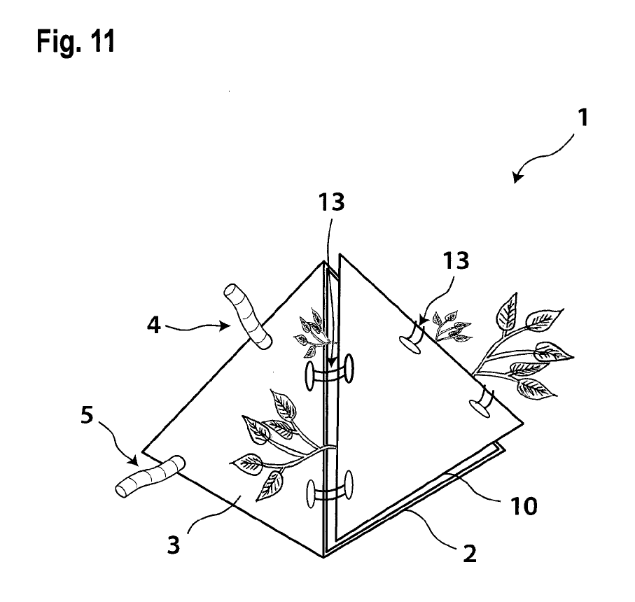

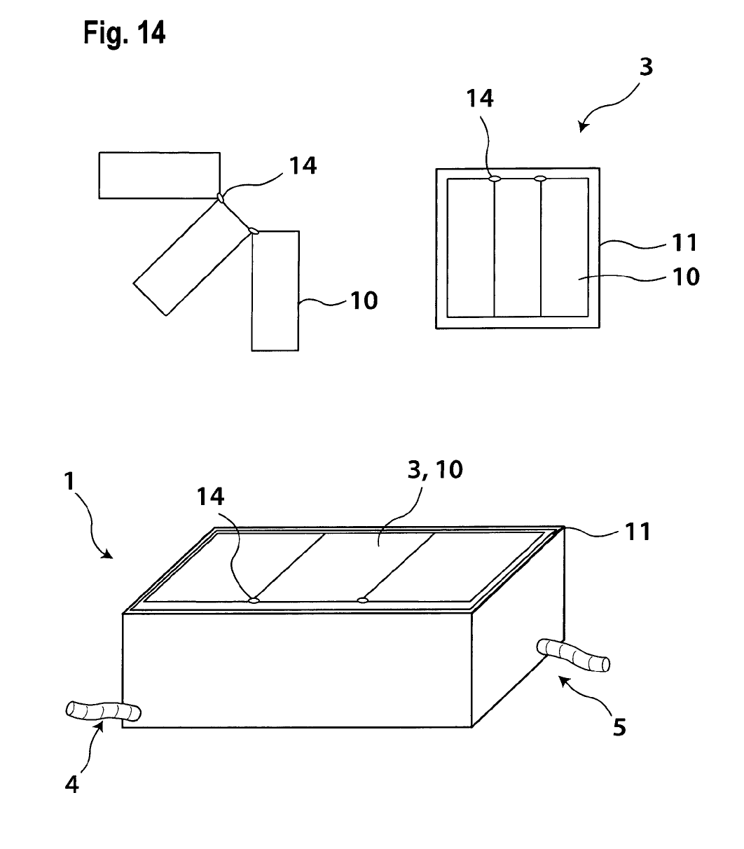

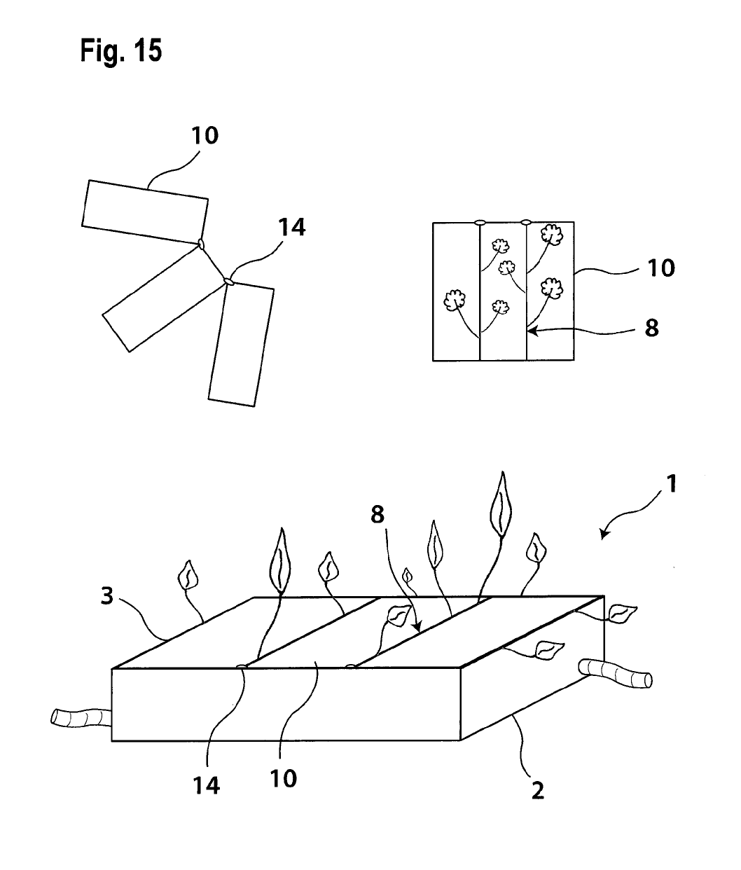

Various versions of segmented covers 3 are apparent from FIGS. 7 to 15. Some, for example, completely detachable or pivotal cover segments, are in this context always denoted by the reference numeral 10. The cover segments 10 are either connected to the basic container body 2 directly or via a frame 11. In FIGS. 7, 8 and 10 a straight spraying pipe 12 is installed in the interior of the container in a horizontal position. Different types of hinges 13, 14, according to FIGS. 11 to 13, connect the respective cover segments 10 to one another and/or a cover segment 10 to the basic container body 2. In the working example according to FIG. 11, fixations, which may serve as hinges 13 as well, are realised in a simple manner by using strings or strips, preferably of flexible design, retained on cone-shaped or similar contours of the container 1. In this way, the cover segments 10 can be removed particularly easily from the basic container body 2 as well.

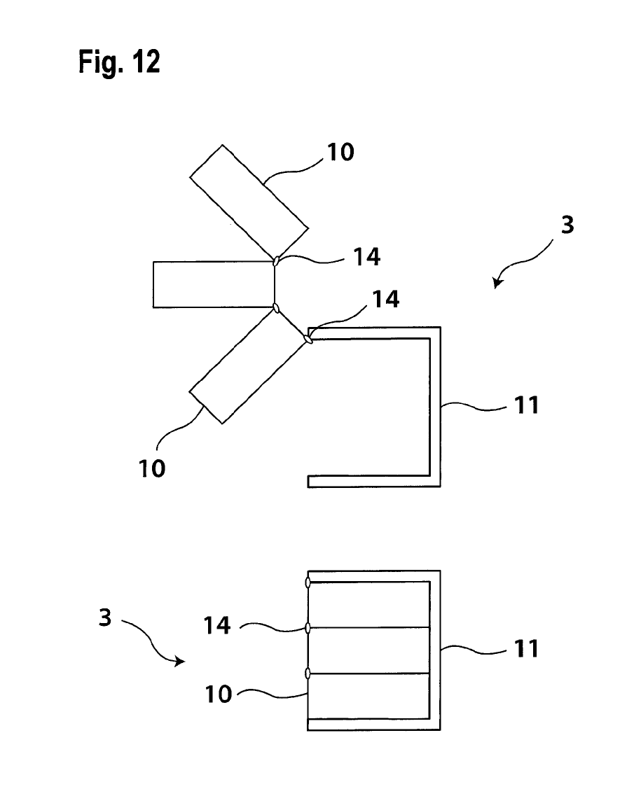

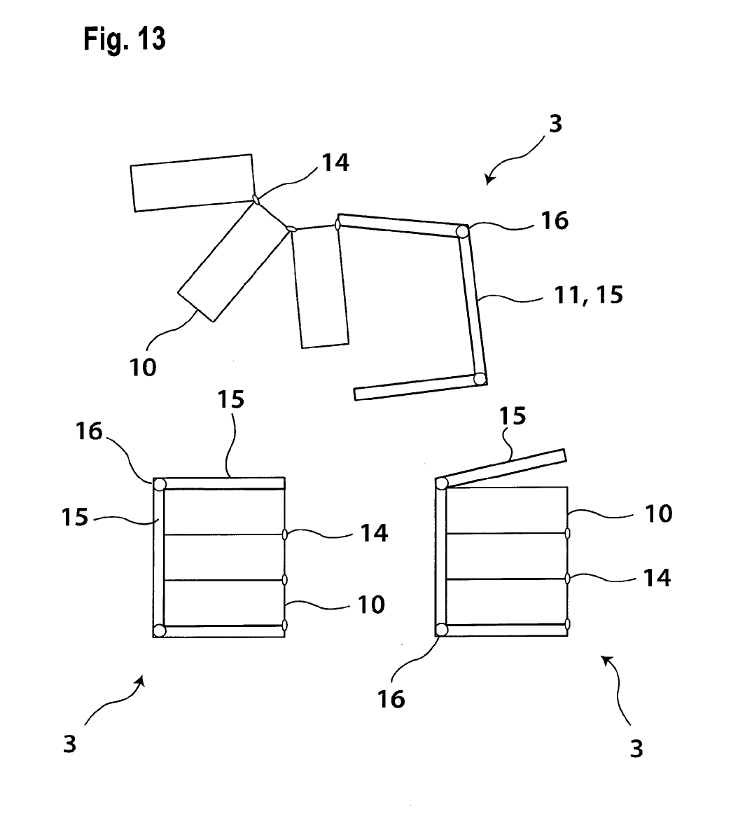

Instead of a closed frame 11, as shown in FIG. 7, an open U-shaped frame 11 as shown in FIGS. 12 and 13, may be used as well, which significantly improves handling. In the case of FIG. 13 the frame 11 is composed of frame segments 15 which are interconnected by hinges 16.

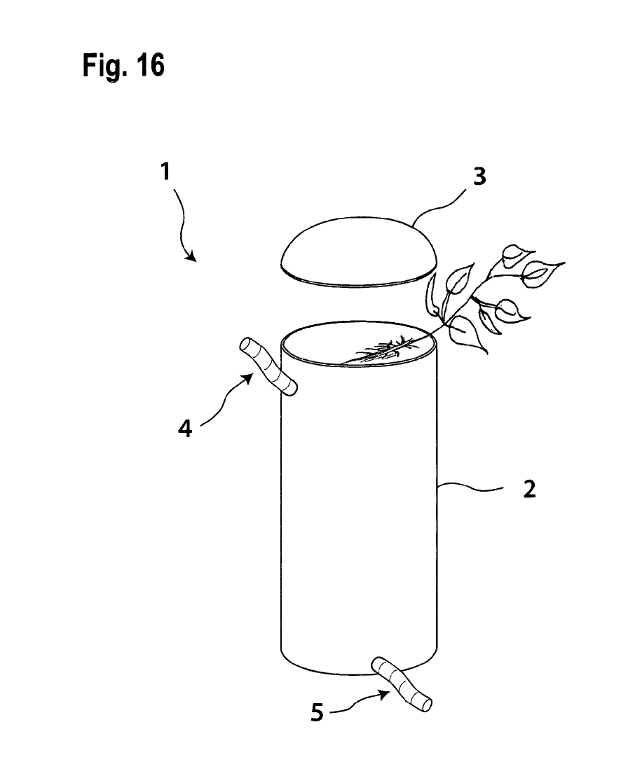

In the working example according to FIG. 16, the basic container body 2 is cylindrical and covered by a circular disc-shaped cover 3. Like in the working examples according to FIGS. 1 to 3, in this case as well plants can be so cultivated that they grow out of the container interior through a separating slot 8 between the basic container body 2 and the cover 3.

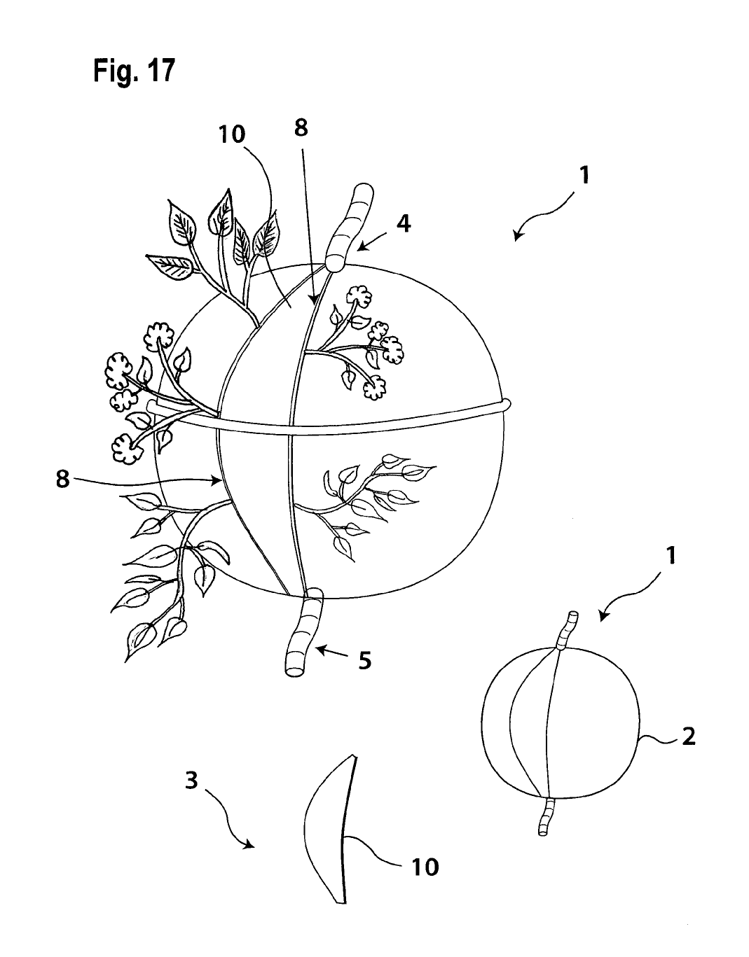

The container 1 according to FIG. 17 has a spherical configuration, the cover 3, in the form of a segment, being adapted to be removed from the container surface. Instead of a single segmented cover 3, as outlined in FIG. 17, a plurality of cover segments 10, in each case describing a section of a spherical surface, may likewise be detachable from the basic container body 2. In an extreme case, the entire spherical container 1 may be composed of cover segments 10, which mutually support one another. This applies analogously also to other configurations of the container 1. The container of any geometry may also be configured in the form of a skeleton or may contain, for example, a skeleton composed of steel mats and/or steel bars, which may further perform a support function for ducts, for example liquid ducts and/or data lines.

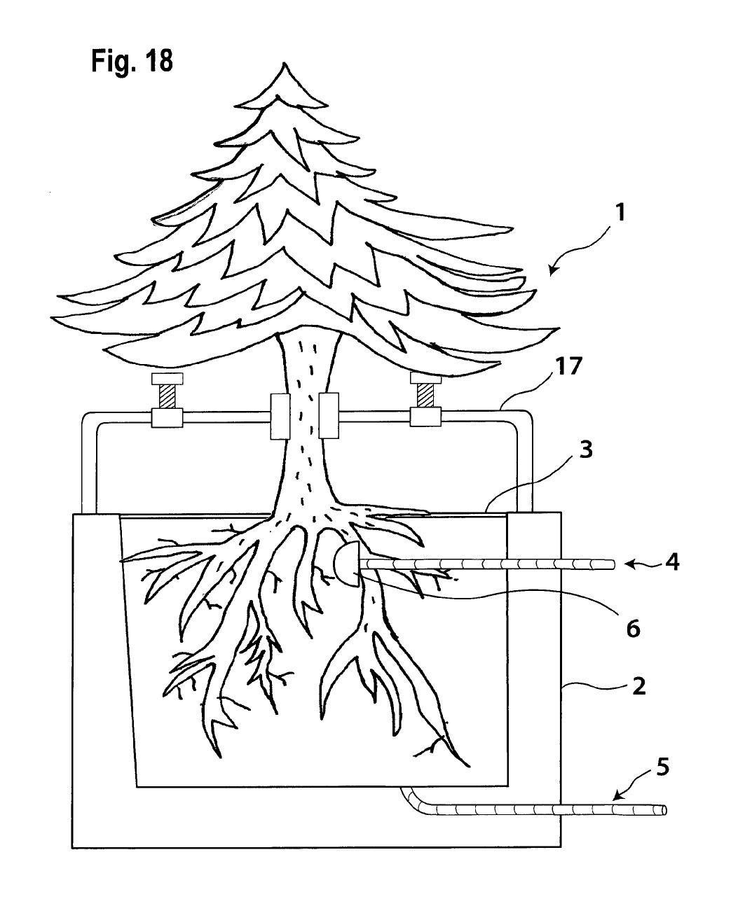

In contrast to the working examples according to FIGS. 1 to 17, the container according to FIG. 18 is designed for a single plant only, namely a tree. The container 1 according to FIG. 18 includes a multi-part, adjustable support device 17, which in the present case is fitted directly to the basic container body 2.

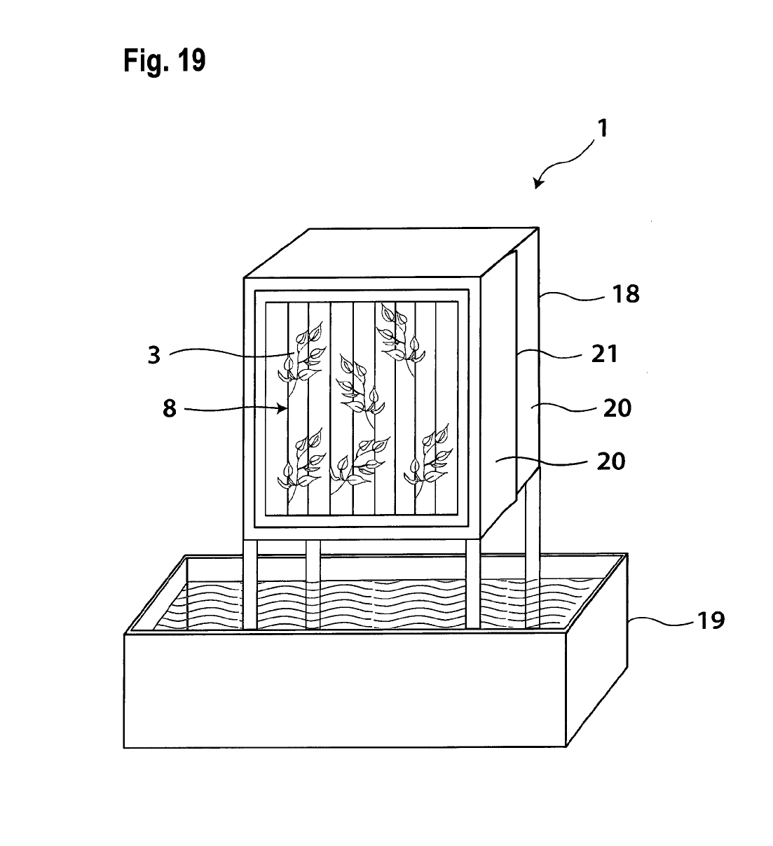

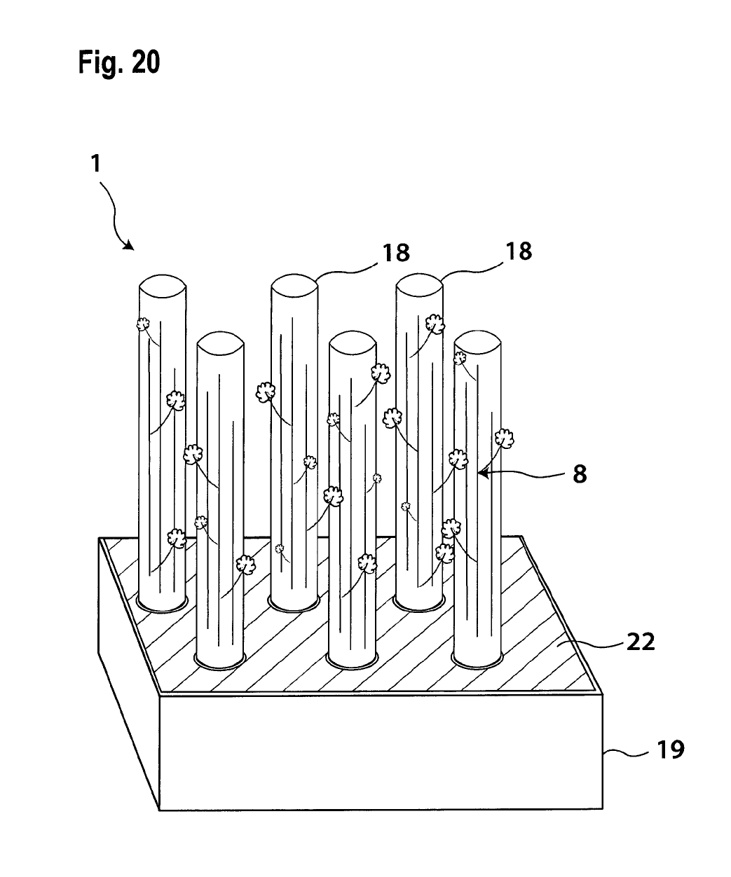

FIGS. 19 and 20 show embodiments, wherein a single column body 18 or a plurality of column bodies 18 is/are assembled with a basic container 19 provided underneath the latter. The basic container 19 is in this context configured as a watertight trough. The cuboid column body 18 in the case of FIG. 19 includes two overlapping foil sections 20 on one lateral face, between which an access slot 21 is formed. The separating slots 8 are provided on another lateral face of the column body 18.

In the case of FIG. 20, the column bodies 18 are cylindrical, separating slots 8 being provided around half the circumference of the column body 18. The other half of the circumference is configured as a closed, white, optimally light-reflecting surface. A cover surface 22 on the basic container 19, visible in FIG. 20, is designed to be walked on.

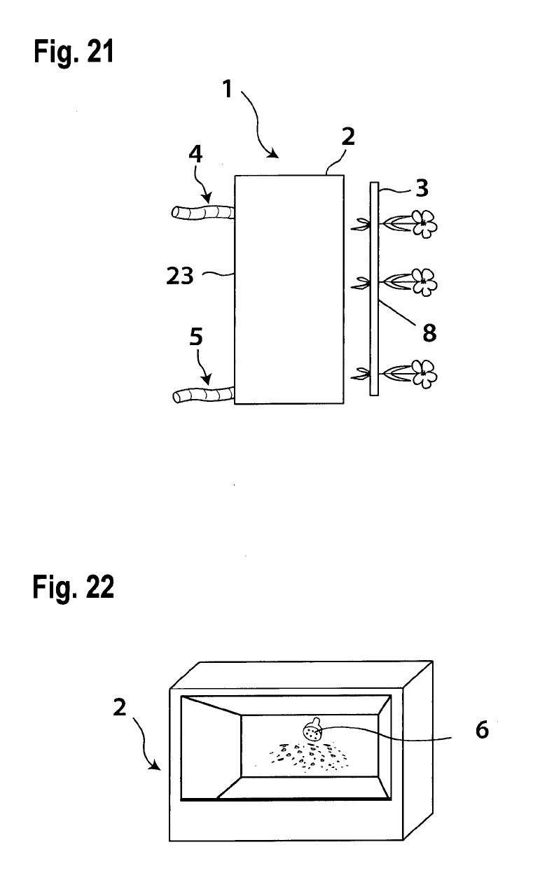

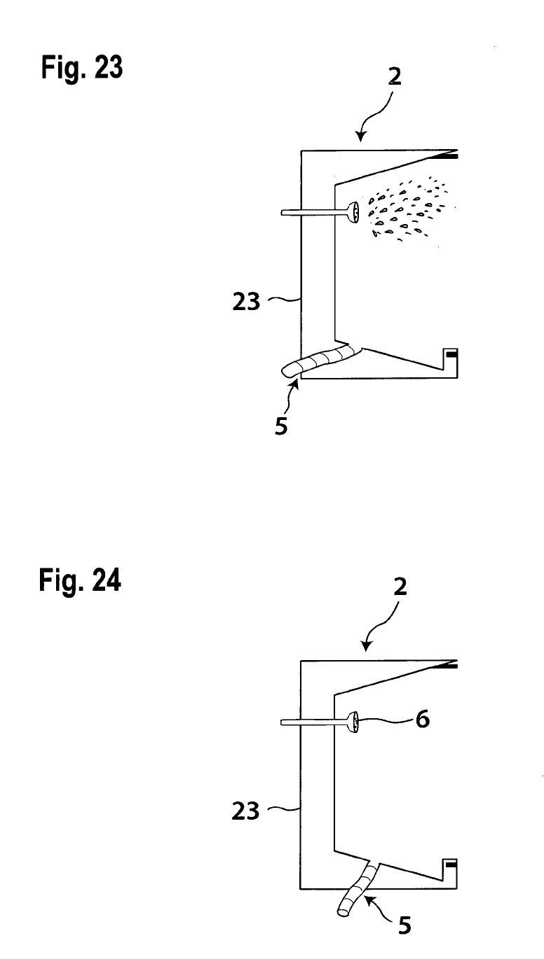

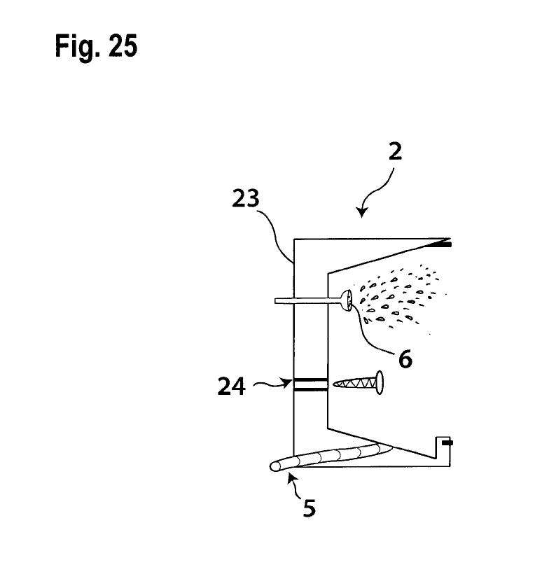

FIGS. 21 to 23 show a first working example of a container 1, the basic container body 2 of which is made of concrete. The basic container body 2 is thus suitable as a structural element for establishing a wall. At its rear wall, denoted by 23, the basic container body 2 is configured at its thickest; the wall thickness decreases towards the cover 3. The discharge duct 5 in the example according to FIGS. 21 to 23 exits from the basic container body 2 on the rear wall 23. In contrast thereto, the discharge duct 5 in the working example according to FIG. 24 is positioned at the bottom of the basic container body 2, in which case, at this location, a transfer of liquid into a feed duct, not shown, of a further structural element situated underneath the latter may be provided. In the design according to FIG. 25, the basic container body 2 is provided with a screw connection point 24 on its rear wall 23, permitting, for example, the container 1 to be screwed-on to a load-bearing structure. The container 1 can therefore also be used as a wall cladding element, for example a tile.

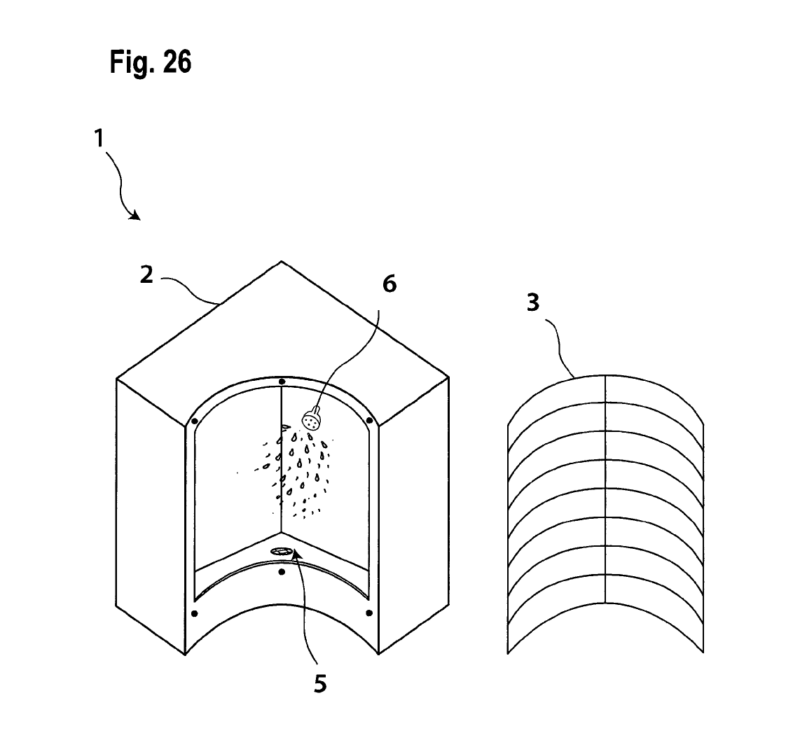

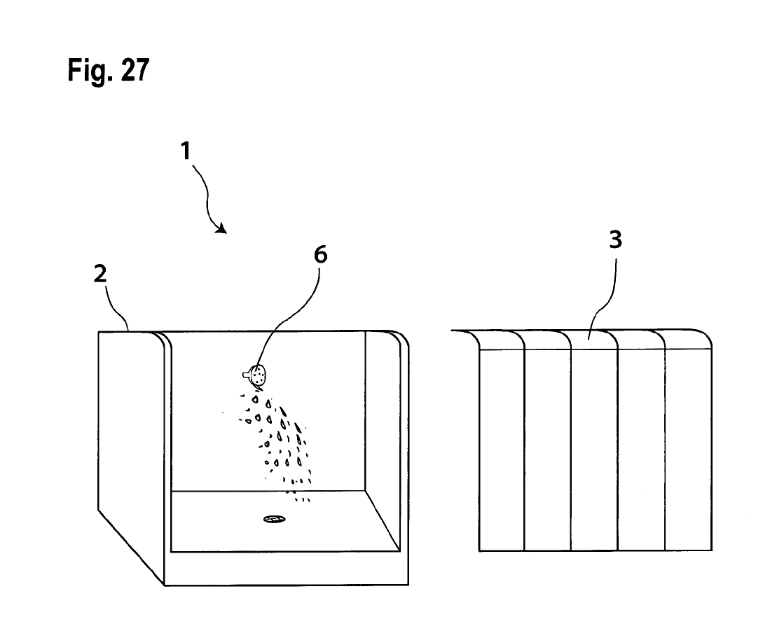

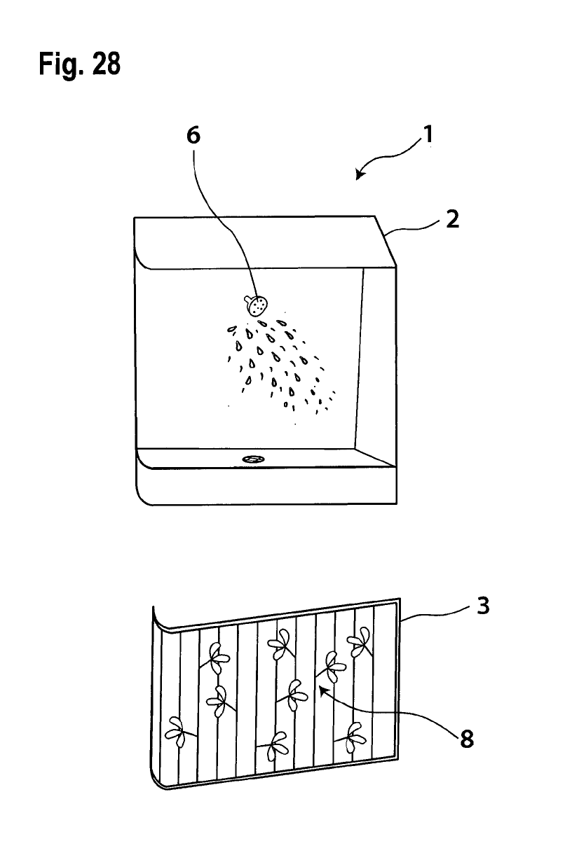

The containers 1 according to FIGS. 21 to 25, inside a structure, can be combined with each of the containers 1 according to FIGS. 26 to 28 or with commercially-available wall stones, for example, concrete blocks, bricks, sand-lime bricks or expanded concrete blocks. In this case, the container 1, in the case of FIG. 26, acts as an inner corner element, in the case of FIG. 27 as an upper edge element and in the case of FIG. 28 as an exterior corner element of a wall. The discharge duct 5 can in all cases be provided either on the underside or on the rear wall 23 of the respective container 1. By way of a raised edge, that is to say, a lip, on the front face of the container 1, a defined quantity of water can accumulate therein.

In the example according to FIG. 29, the container 1 is configured in the form of a roof tile. A nose 25 is visible on the underside of the container 1, which serves to retain the container 1 on a roof structure, like a conventional roof tile. The discharge duct 5, comparable to the working example according to FIG. 24, may be provided to transfer liquid into a further roof tile-shaped container 1. A discharge duct can likewise be connected to the container 1, which continues inside the building.

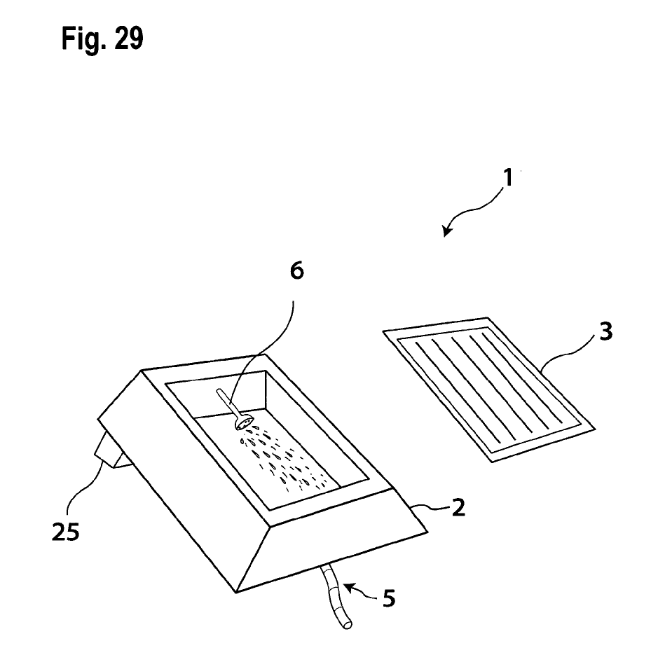

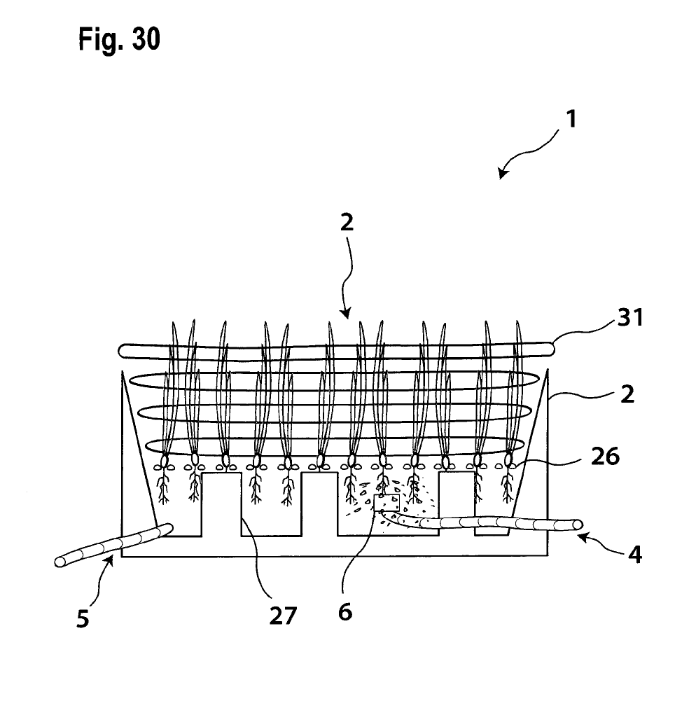

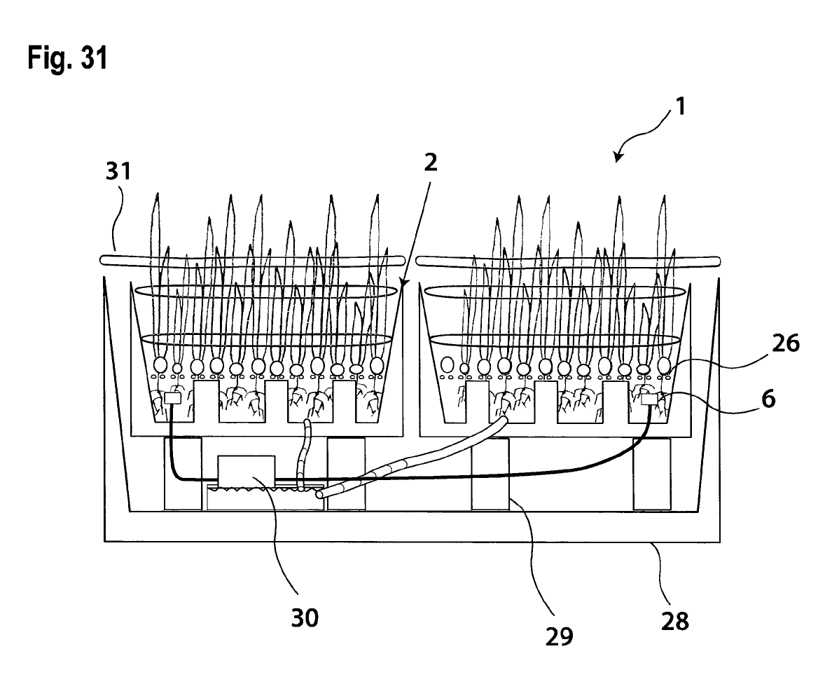

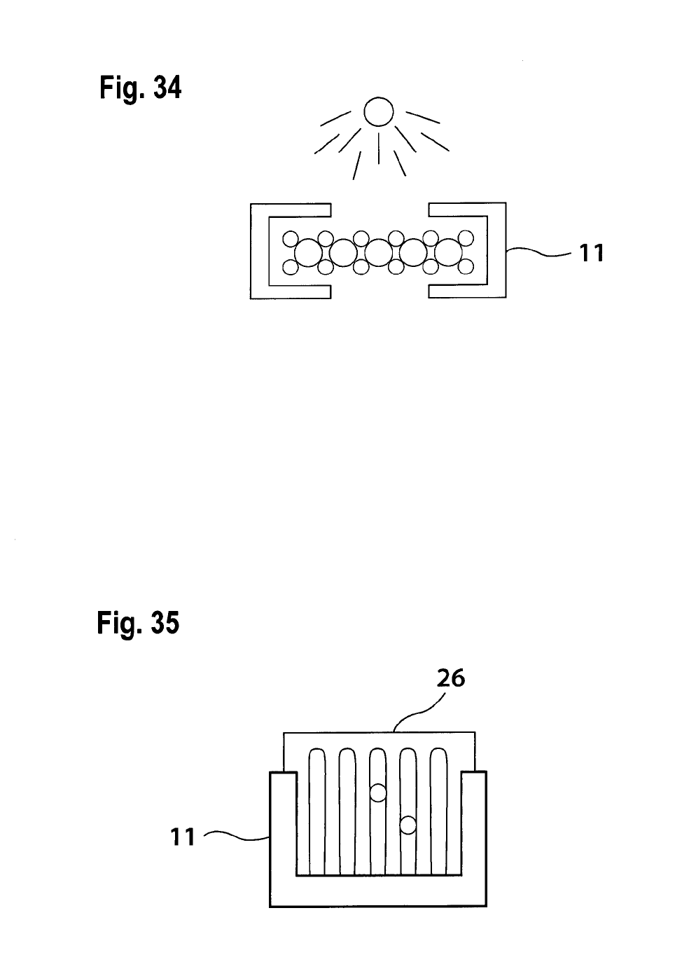

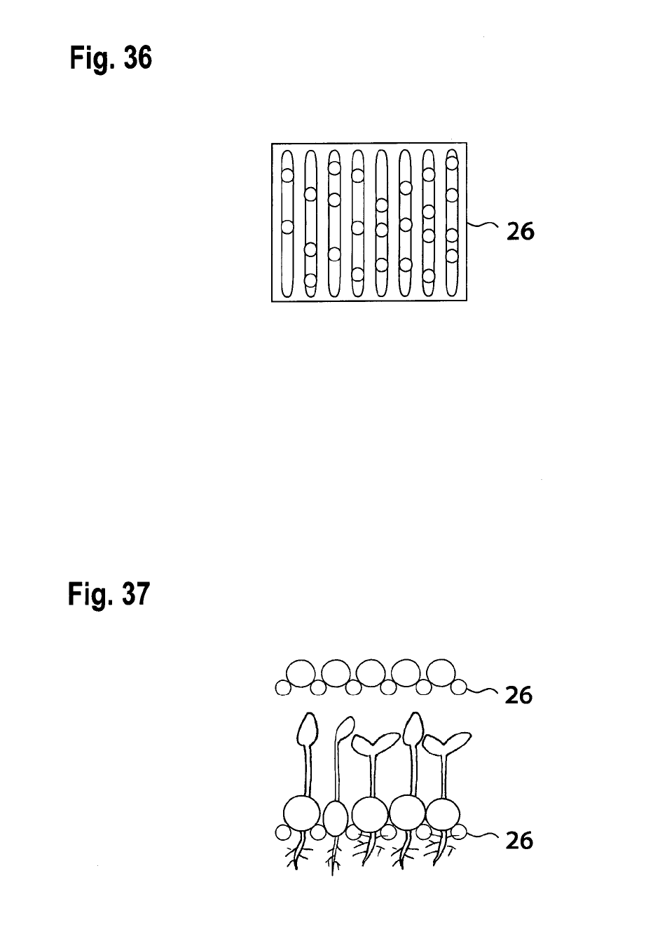

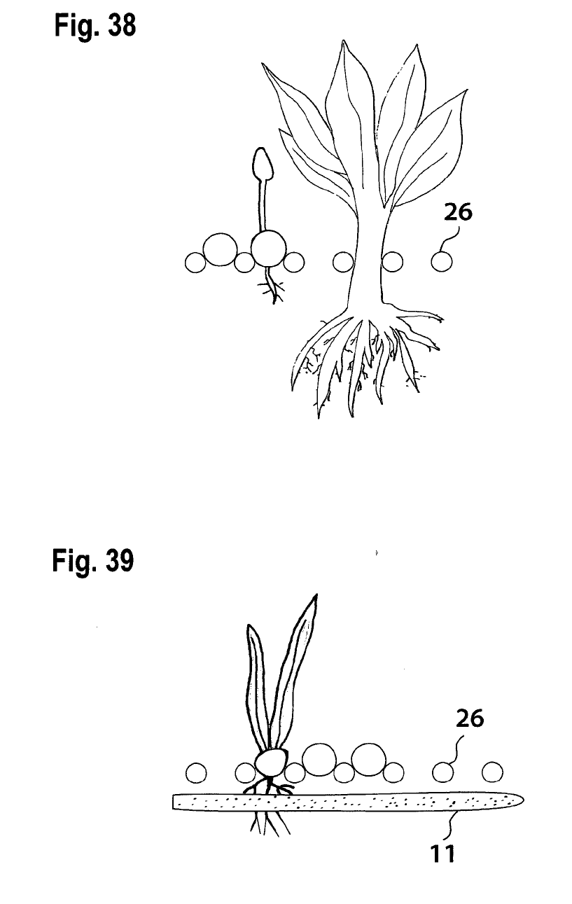

FIGS. 30 to 41 show various features of containers 1 suitable for surface greenery. Instead of a cover, a grating 26 is in this case placed onto the basic container body 2. Grass seeds can germinate over the grating 26 or between two superimposed gratings 26. Support means 27 may form integral parts of the basic container body 2, like in the example according to FIG. 30, and directly carry the grating 26. According to FIG. 31, a plurality of basic container bodies 2 are provided in a larger collecting trough 28, supported there in turn by supporting elements 29. The interior spaces of the basic container body 2 are connected to the interior of the collecting trough 28, underneath the basic container body 2, via feed ducts 4 and discharge ducts 5. In this space underneath the basic container body 2 a pump 30 is also present, generally referred to as actuating element, which supplies each basic container body 2 with nutrient solution. Alternatively, each container 1 may be equipped with a pump 30 of its own.

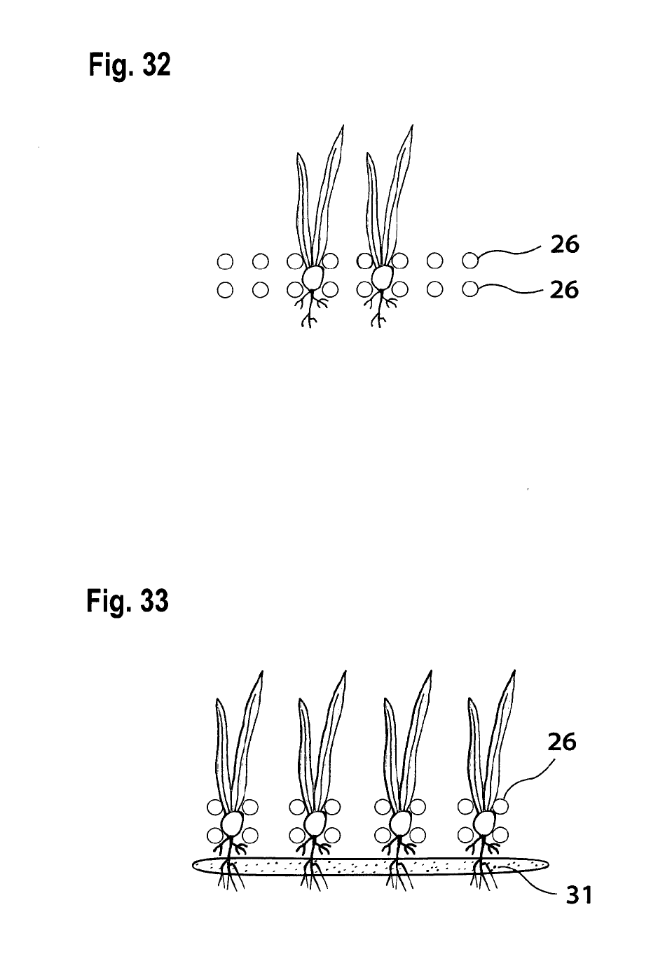

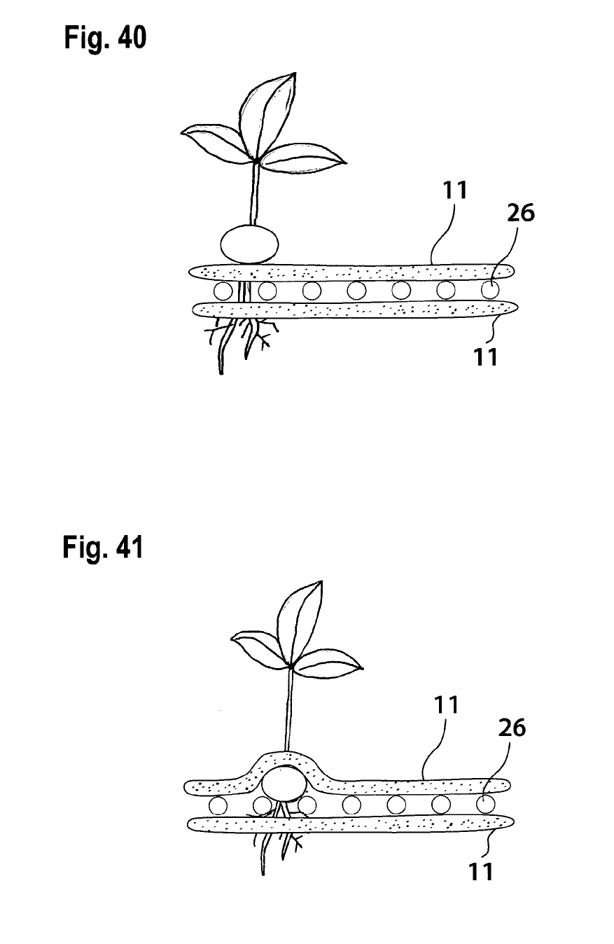

Above the grating 26 (FIGS. 30, 31), underneath the grating 26 (FIGS. 32, 33, FIG. 39) or in sandwich fashion above and underneath the grating 26 (FIGS. 40, 41) a textile mat 31 may be provided. The term “textile mat”, regardless of the manufacturing process, also encompasses, apart from mats of natural- and/or artificial fibres, layers of paper or cardboard or other flexible, non-waterproof materials, including composite materials.

In contrast to the horizontal arrangements of the container 1 suited for surface greening, vertical arrangements are possible as well, in particular for façade greening. Particularly in the latter case, a frame 11 encompassing the grating is advantageous.

In the case of using the container 1 for creating a lawn area on the surface thereof, the components of container 1 are designed sufficiently stable so as to permit loads applied by persons or vehicles. A sufficiently thick textile mat 31 prevents that load-bearing structures of the container 1 are perceived as objectionable when stepping onto the lawn area.

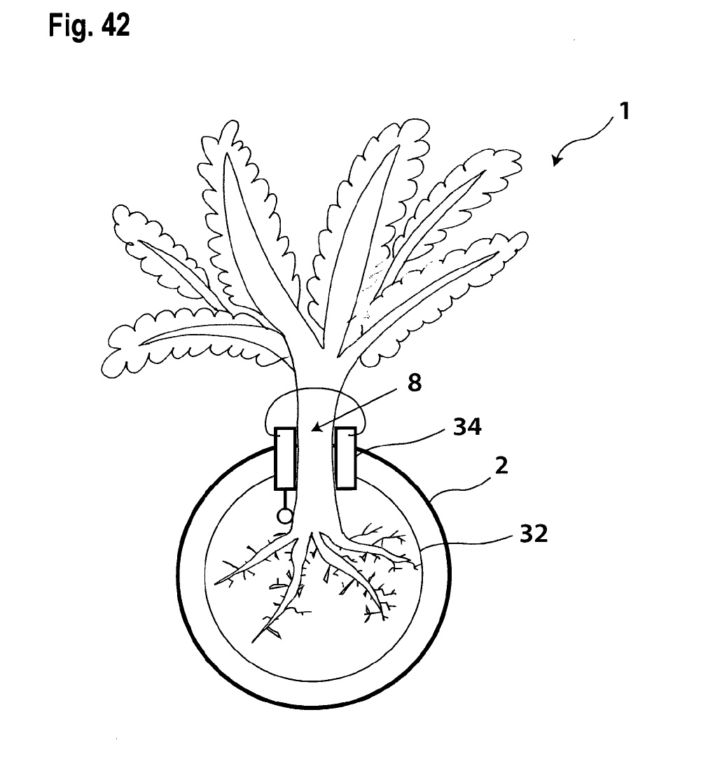

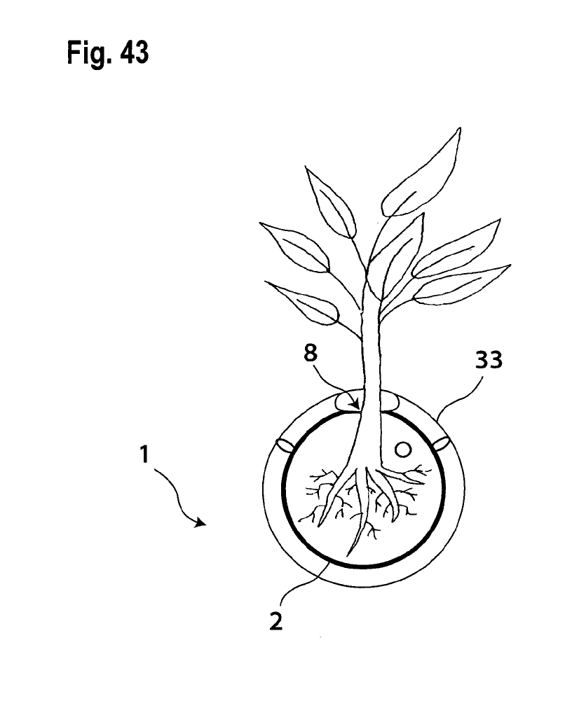

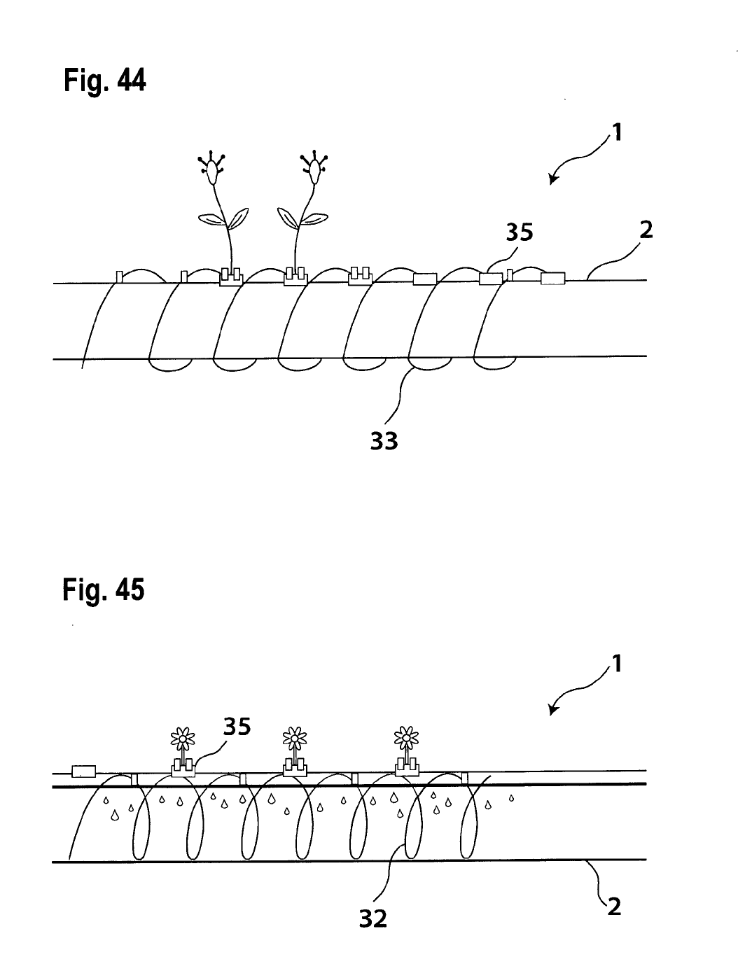

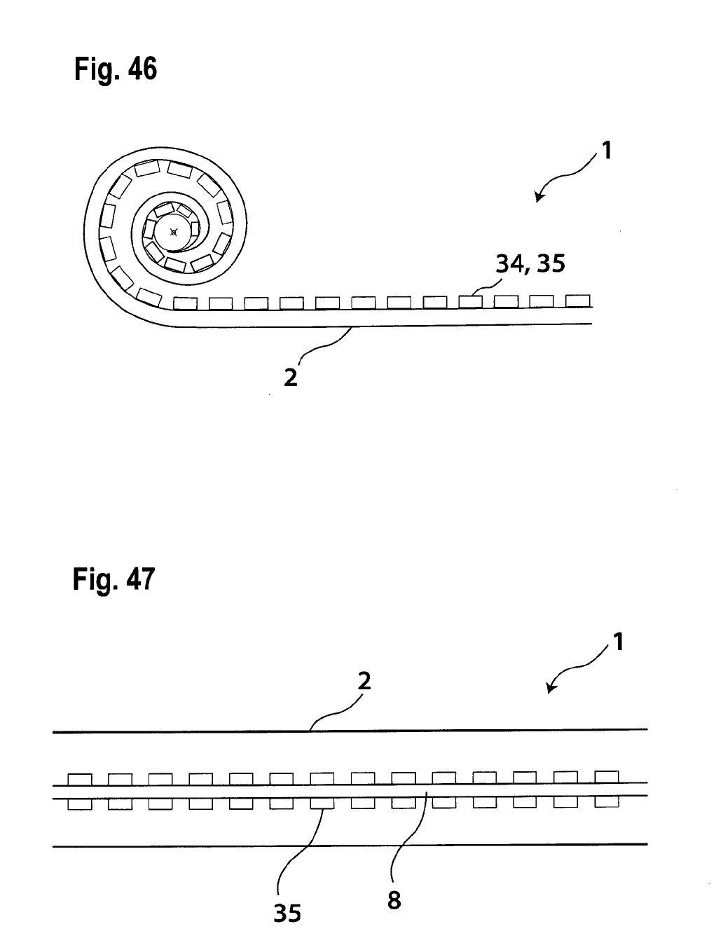

FIGS. 42 to 44 show different embodiments, wherein the container 1 is hose-like. The separating slot 8 is in this case formed as a longitudinal slot on the upper side of the hose-like container 1. An endoskeleton 32 (FIGS. 42, 45) or and exoskeleton 33 (FIGS. 43, 44) may serve to mechanically stabilise the hose representing the container 1. As it can be seen from FIGS. 46 and 47, lips 34, formed by individual lip regions 35, separated from one another, are provided on the separating slot 8. The lip regions 35 ensure a particularly gentle contacting of plant parts at the separating slot 8 and do not appreciably limit the flexibility of the hose when it is rolled up.

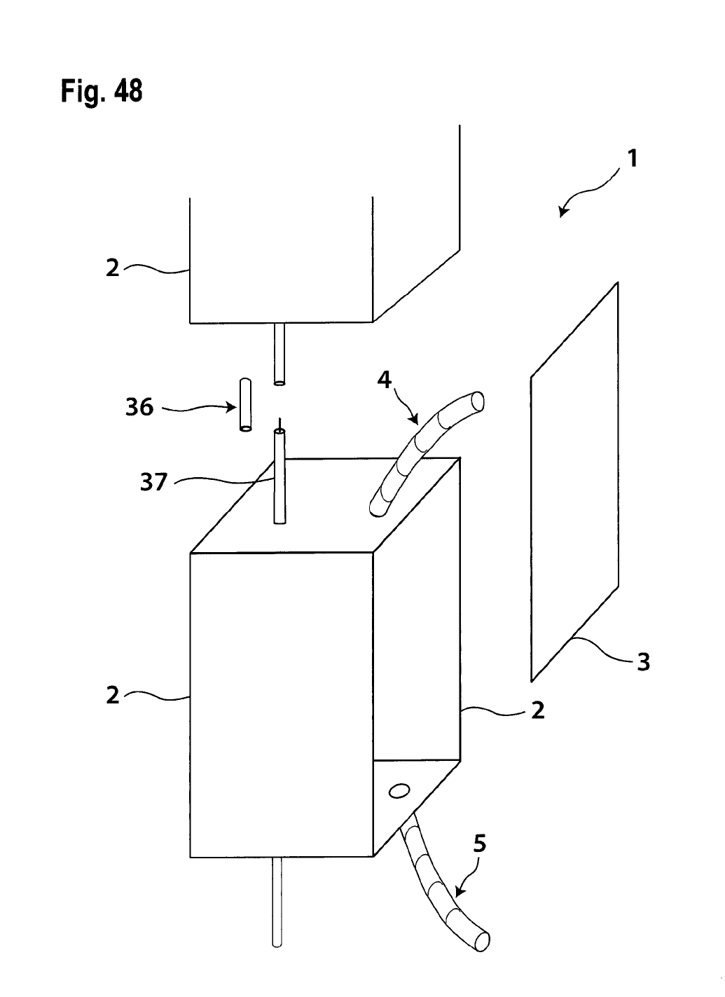

FIG. 48 shows a section of a load-bearing structure, overall denoted by 36. The basic container body 2 is integrated into this load-bearing structure 36, but does not as such represent a load-bearing element. Rather, the basic container body 2 is traversed by a support structure 37, which is adapted to be connected to further structural elements, in order to complete the load-bearing structure 36. The support structure 37 is in this case to be understood as a component of the container 1. The load-bearing structure 36 may, for example, be a building structure or part of a building structure, for example a bridge or a façade.

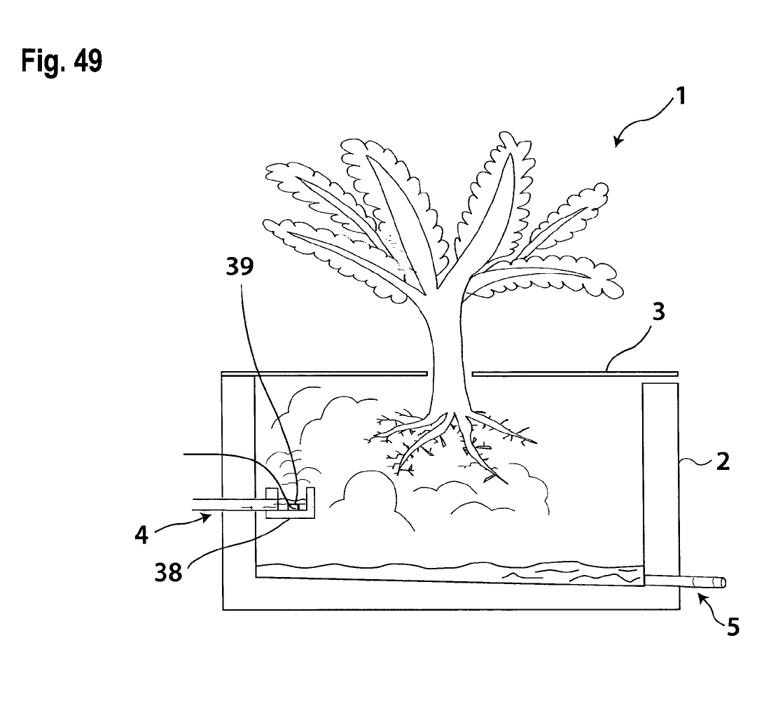

FIG. 49 shows a possible way of supplying nutrient solution to the container 1, which, in this case, is configured as an aeroponic container. The nutrient solution is converted by an atomiser 38 into an aerosol, which can be received through the plant roots. The atomiser 38 can be used in all afore-mentioned configurations of the container 1. The atomiser 38 accommodates an ultrasound source 39, which is covered completely with liquid. Condensate forming inside the interior of the container is drained via the discharge duct 5.

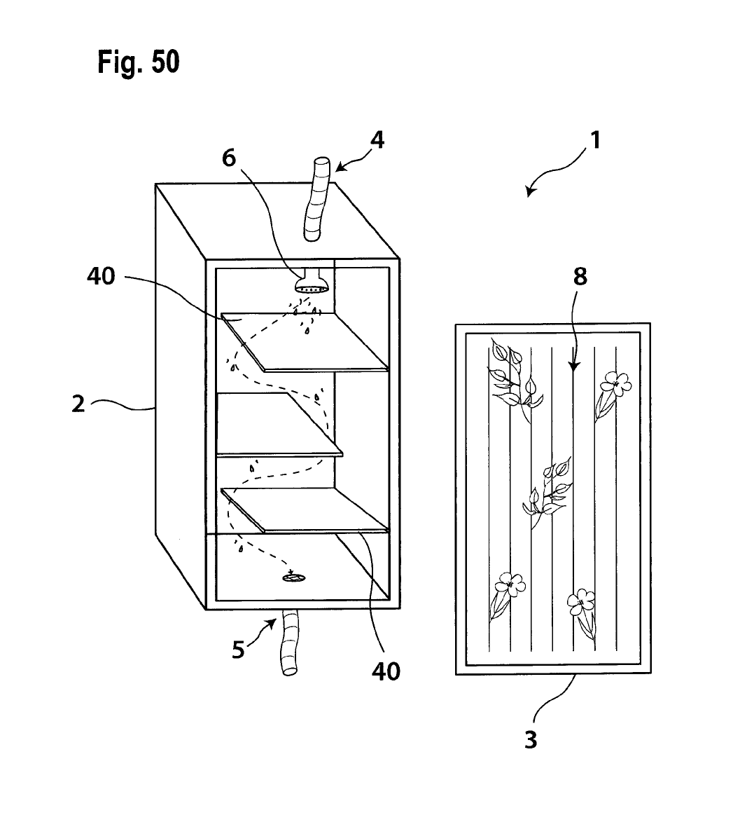

In the working example according to FIG. 50, a plurality of water-feed elements 40 are discernible in the interior of the container 1 in the form of feed surfaces. The nutrient solution is in this case supplied in liquid form by the spray nozzle 6. Water-feed elements 40 may additionally serve to retain substrate, not shown, in the designated regions inside the container 1.

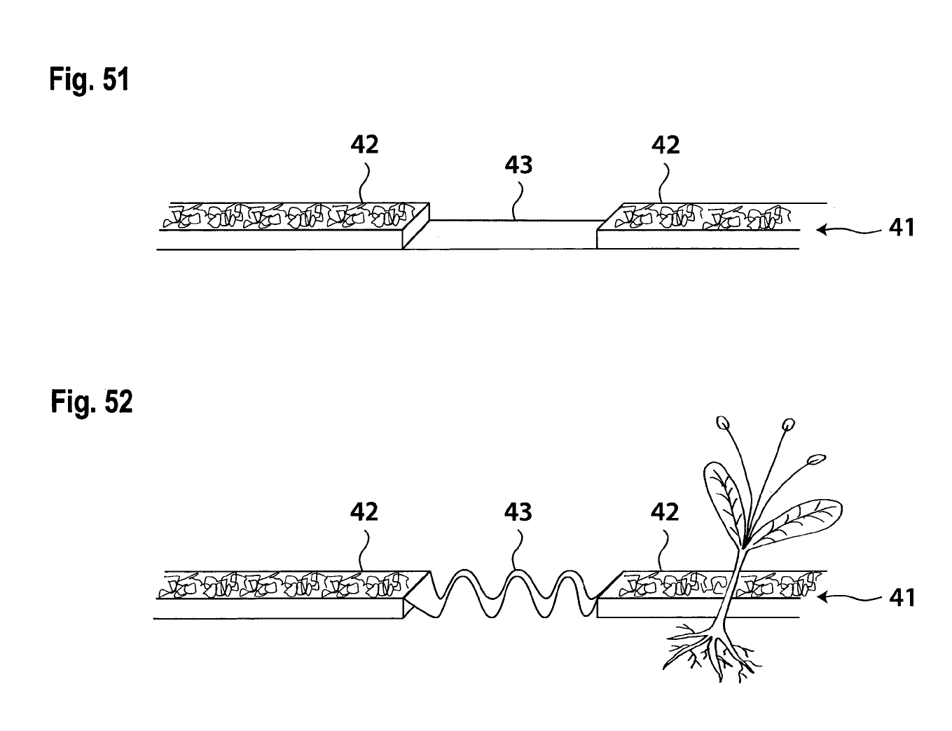

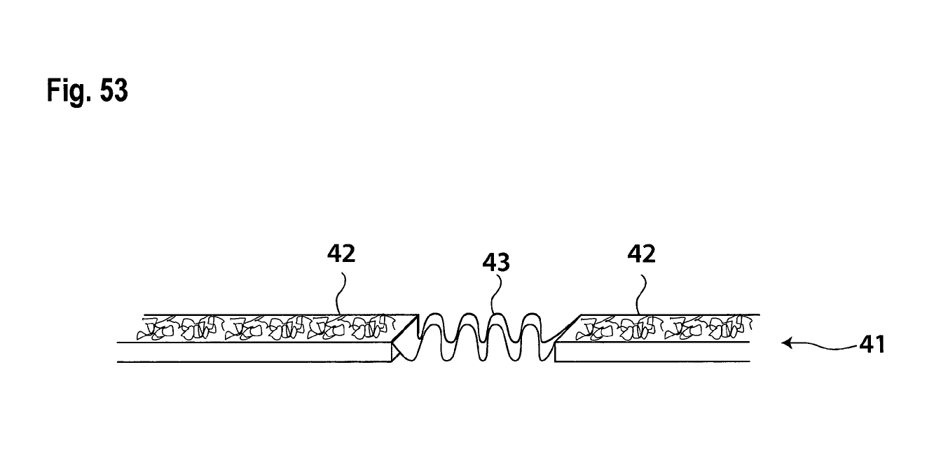

The very wide range of basic configurations of the container 1 allows foam strips 41, shown in FIGS. 51 to 53, to be inserted into the separating slot 8. In order to be able to perform adjustments to different space requirements of the plants when the container 1 is in operation, the foam strip 41 is subdivided into individual sections 42, which are interconnected by a foldable strip 43. The foldable strip 43 may be configured as a foil, a foam element or as a composite element of foam material and foil, accordingly presenting different characteristics with regard to permeability to liquids and plant parts. The container 1 can be comfortably charged by initially placing the plant material onto the foam strip 41 and subsequently positioning the complete foam strip 41 into the container 1. In this context, it is particularly advantageous if the foam strip is provided on a strip of firmer material during charging, for example in the form of a lip, and if this strip including the foam strip is subsequently introduced into the container 1.

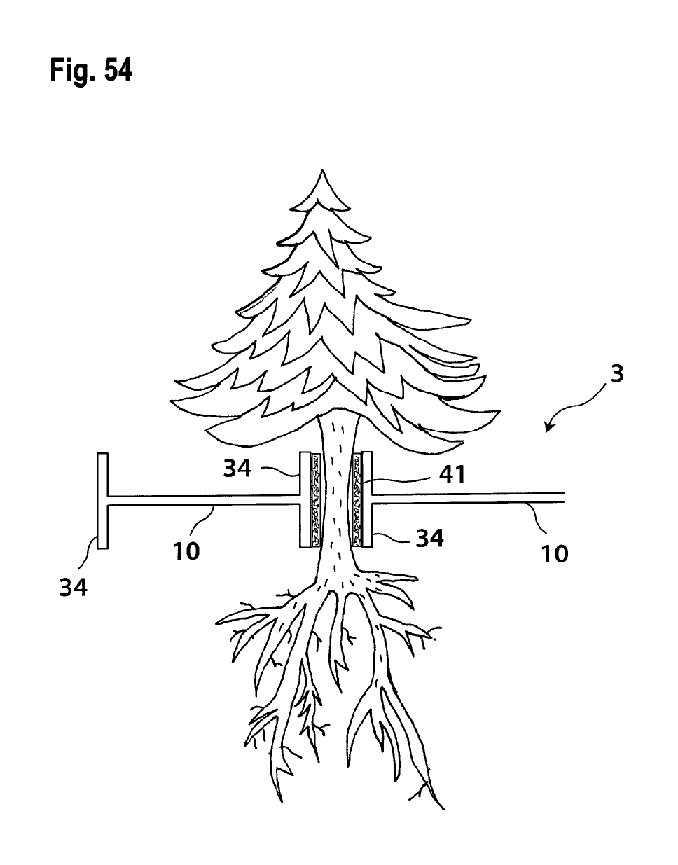

Foam strips 41 are also used in the working example according to FIG. 54, showing a section of a completely fitted out container. The foam strips 41 rest in this case against the lips 34, which form integral parts of the cover segments 10. In comparison with the wall thickness of the cover segments 10, the lips 34, each situated in planes orthogonal to the cover segments 10, provide a much broader abutment area for the foam strips 41 and thereby for the plants as well.

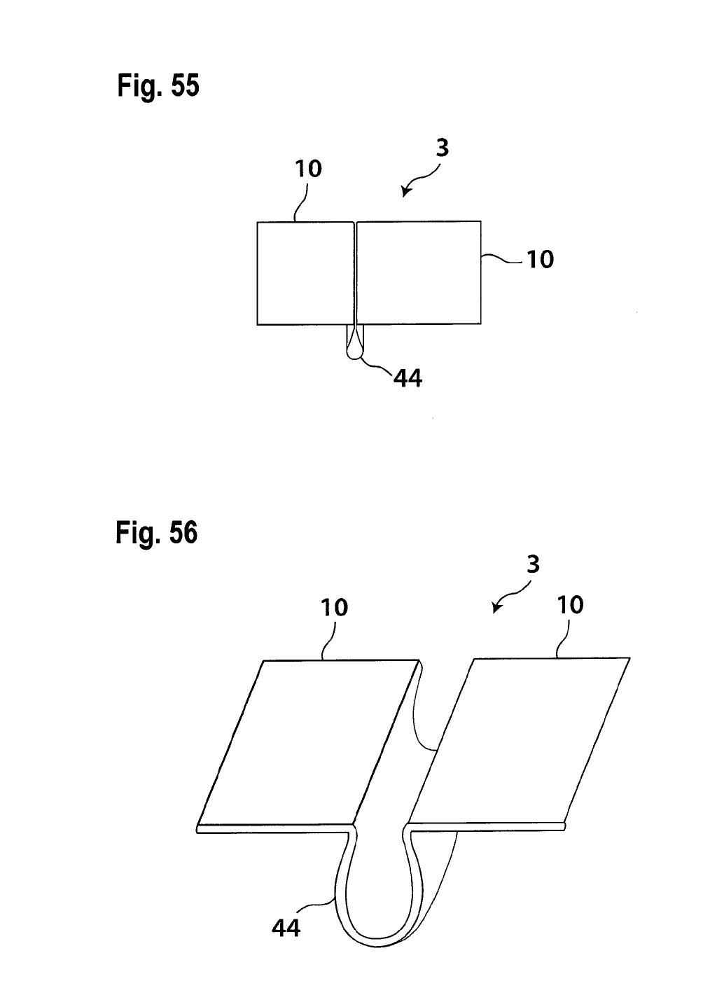

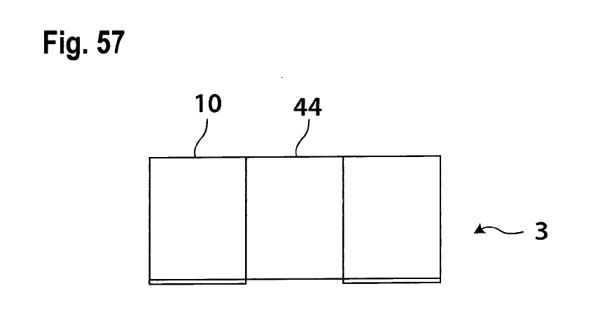

FIGS. 55 to 57 show a possible flexible connection between two adjacent cover segments 10 at locations where the separating slot 8 is closed. The cover segments 10 are interconnected by a foldable foil strip 44 at the appropriate point. At the side lines of the cover segments 10 facing away from the foil strip 44, lips may in each case be provided, such as shown in FIG. 54.

Further text to follow.

Prior Art—Description

Nathaniel Storey
Container (“tower”) with 1 slot at the front (in the centre)
Upper and lower aperture (adapted to be closed on the top)
Substrate (as “matrix”/foam material) in 2 halves (folded)
Suspension in drilled holes (various angles)

Disadvantages:
Only one slot per container
Front cannot be used fully for vegetation, since slots only part of the surface
No other sides or edges used
Slot at the front not flexibly adjustable
Smaller plants:
   No support on container wall
   Not perfectly/accurately positionable
   May fall out in the event of poor rooting (seeds as well)
   May be flushed away by nutrient solution
   Possibly missed by nutrient solution
Larger plants:
   Damage to stem at slot edges when pulling in together with substrate
   Jamming possible, substrate (foam matrix) may possibly not fully enter the container
Substrate: Distribution of nutrient solution unpredictable

Uncertain whether young plants, seedlings, seeds are always reached uniformly
No substrate:
   Fixation unclear
   Falls out—lopsided suspension
   Increased loss through evaporation (in general)
   Aerosols leave the container through the slot (moisture in the surroundings—negative for interior greenery)
General: Moisture enters/leaves through the slot in an uncontrolled manner

Description

Continuation Nathaniel Storey—(Prior Art)

Discharge of liquid through slot (front)
Increased evaporation
Dripping through the slot if handled incorrectly

Entry of environmental impacts through the slot (rain, dust, pests, . . . )

Façade greening
Too much of front container wall visible
Only slot can be greened
Young plants or narrow-growing plants cannot cover the front
No “lawn formation” possible on the front
Aesthetically usable to a very limited extent

Cannot be walked on/driven on

Cannot be integrated in structure in a load-bearing manner

Cannot be rolled up

When planning, hardly any play with lines and patterns, aesthetics

Roots are the main point of fixation for plants on the container
Accurately-located germination difficult/impossible
Roots of plants which already have roots are clamped between two substrate blocks during planting and are subsequently clamped with the latter into the container—damage to the roots—, little free space for root formation until new roots have been formed
Plant suffers in the event of damage to the roots
Fine roots are lost during planting

Growing potatoes is difficult, no harvesting in operation

Prior Art—Description

Soil-bound façade planting
Very heavy weight—difficult statics
Partial support required
The above causing very high cost

Aerosol-based potato-growing (and similar plants)
To date no separate vertical containers, which can be connected to base for maintenance and which can be operated separately (planting, harvesting, . . . )

Container enclosing entire plants
Limitation of growing space
Harvesting/care made more difficult through container

Containers, which have a clamping effect, but with flexible apertures (circular rubber sheet, divided crosswise)
Few plants possible per area
Spacings pre-defined, cannot be varied
No stable support of the plant (too flexible, possible shifting in all directions)
Rubber may damage roots during planting due to elastic rebound

Hydroponics with grid
Not designed in a manner to be walked on
Cannot be used vertically

Object (main claim 1.)—Description
Root-friendly planting
Root-friendly support
Exact positioning when planting the container with seeds, seedlings, cuttings or plants.
Avoid shifting (including the prevention of forces caused by nutrient solution)
Facilitate mechanical planting
Floral/greening designs for different façade configurations, ceilings, artistic shapes

Solutions
Clamping the stem instead of the roots
Clamp parts without roots
Clamp to the container wall instead of to the substrate
Use a variety of bodies (both on the rear side and on the vegetation side)

Advantage
Healthier roots, because the latter are undamaged
Plant performs better, as roots do not need to reproduce (performing better more rapidly)
Plant patterns and spacing can be better planned

Object (claim 2.) Description
Provide individual containers fed from below (notably for aeroponics)
Container can be planted, transported and harvested individually, can be separated (quarantine)
Containers placed next to one another can be handled ergonomically
Joint nutrient source (e.g. aerosols)

Solution
Basic container with apertures towards narrower individual containers from which basic container aerosols enter into the latter
Containers individually detachable from the basic container

Advantages
No suspension device and feeding required from above (preventing shadow-casting, saving on construction)
Can be handled from the side without having to bend down (because of being vertical)

Object (claim 6.) Description
It should be possible to plant roofs in the absence of soil
Replacement of roof vegetation should be facilitated

Solution
Basic container body open towards the upper side and can be planted in the absence of soil
Feed ducts exit from the container

Advantage
Seasonal planting possible
Removal of dead plants
Simple watering at any time+for varying requirements

Object (claim 3.) Description
Allow robust façade greening in the absence of soil
Using materials used in the building industry (structural properties, optics, . . . )
Allowing integration with structures
To be used as a varied loosening-up of a façade, without breaking up the façade area with containers
Facilitating change of greenery/vegetation

Solution
Load-bearing design, using materials in the basic container body suitable for construction purposes
Convert visible fronts, at least in part or entirely, into façade greening by means of plantable elements (covers etc., gratings)

Advantages
Optical enhancement of façades
Acts as part of the façade when being looked at
Statics of the structure remain advantageous
Cost savings in relation to soil-bound façade greening (or, respectively, non-“airy” substrate instead of soil)
Assembly partially possible to be performed by bricklayers, no drilling etc. for fitting
Feeding etc. can be performed retroactively, e.g. from behind, or already through simple installation, if performed by joining technology, proceeding inwardly.

Object (claim 4)—Description
Improve the statics
Enable wide growth at the font and root area behind

Solution
Stronger wall thickness in the rear portion
More hollow space in the front portion

Advantages
Higher structures possible above container
Higher load-bearing capacity

Object (claim 5.) Description
Areas where walls end, should likewise be greenable, corners (concave, convex) as well should be joinable in alternating fashion

Solution
The section covering the container aperture is adapted to the modified partial surface of the façade

Advantage
A façade can be greened as a whole, including on outer and upper edges

Object (claim 7) Description
Grow larger-sized plants+trees without soil at any desired location
Ensure stability
Introduce roots without damaging them, protecting the roots when growing

Solution
Container with sufficient root space according to claim 1
Support device
Detachable cover

Advantages
Facilitating the transport of living trees or moving them to locations where less weight is tolerated
Christmas trees usable as living trees in the season and thereafter

Object (claim 8) Description
Design works of art of any dimension and shape with flowers or greenery
Greening of large structures and buildings retrospectively from the exterior, without interfering with such structures and buildings.

Solution: See claim 8.

Advantage: Any location where a structure is to be erected, can be greened. Outdoor sculptures of large dimensions can be greened, including symbols+logos+script

Object (claim 11.) Description
A container according to 1. is to be adapted for transport and storage in the rolled-up state and deployed in a flexible manner

Solution
The hose includes a separating cut at the top in the flattened state

Advantage
Fewer storage and transport costs
Easier assembly
Can be installed in a manner adapted to the terrain

Object (claim 20.) Description
Increased vegetation density (and even lawn areas) at the container front
Concealing the outer container wall by vegetation

Solution
Design segments so thinly and numerously that dense growth is able to emerge narrowly through a multitude of segment interstices (slots).

Advantage
Aesthetic use possible in façade greening (in the absence of soil)

Object (claim 15.) Description
Minimal spaced-apart relationship between plants growing next to each other
Stable and tight container cover
Can be designed as a façade or area accessible to vehicles

Solution
Use of a grid or grating
Introduce plants between rods or allowing them to grow there through or letting them sprout prior to planting
Plant establishment/sprouting potentially horizontally at the outset

Advantage
Very dense plant carpet
Very strong hold due to rooting and growth through the gaps
Lawn area can be treated without soil
Less cost of irrigation
More tolerant to heat

### LIST OF REFERENCE NUMERALS

1 Container
2 Basic container body
3 Cover
4 Feed duct
5 Discharge duct
6 Spray nozzle
7 Spray coil, drip coil
8 Separating slot
9 Rubber band
10 Cover segment
11 Frame
12 Spraying pipe
13 Hinge
14 Hinge
15 Frame segment
16 Hinge
17 Support device
18 Column body
19 Basic container
20 Foil section
21 Access slot
22 Cover surface
23 Rear wall
24 Screw connection point
25 Nose
26 Grating
27 Support means
28 Collecting trough
29 Supporting element
30 Pump
31 Textile mat
32 Endoskeleton
33 Exoskeleton
34 Lips
35 Lip region
36 Load-bearing structure
37 Support structure
38 Atomiser
39 Ultrasound source
40 Water-feed element
41 Foam strip
42 Section
43 Strip
44 Foil strip

1. Container (1) for supplying plant roots with nutrient solution in the absence of soil, having a basic configuration which is selected from the group of basic configurations including cubes, cuboids, ellipsoids, spheres, rings, pyramids, cones, prisms and cylinders as well as combinations and parts of these configurations and asymmetrical configurations, having a container interior, provided for accommodating the plant roots, and having a separating slot (8) arranged at a boundary of the container interior, and designed to subject at least one plant to a clamping effect, while at the same time allowing said plant to grow.

2. Container (1) according to claim 1, characterised in that it includes at least one column body (18), underneath which a basic container (19) is arranged having a larger cross-section in comparison to the column body (18), the column body (18) being connected to the basic container in a detachable manner.

3. Container (1) according to claim 1, characterised in that a basic container body (2) is designed as a structural element suitable to establish a load-bearing wall.

4. Container (1) according to claim 3, characterised in that the basic container body (2) has a decreasing wall thickness towards a container aperture.

5. Container (1) according to claim 3 or 4, characterised in that the basic container body (2) is designed as a corner element of a wall.

6. Container (1) according to claim 1, characterised in that a basic container body (2) is designed as a roof tile or shingle suitable to cover a roof.

7. Container (1) according to claim 1, characterised in that it includes a multi-part, adjustable support device (17) fixed to a basic container body (2) in order to support a single plant, in particular a tree.

8. Container (1) according to claim 1, characterised in that it includes a non-load-bearing basic container body (2), which can be used as a component of a load-bearing structure (36) by way of a support structure (37) integrated into the container (1) and adapted to be connected to further structural elements, carrying further, in particular additional containers.

9. Container (1) according to claim 1, characterised in that it is designed as a longitudinally slit pipe.

10. Container (1) according to claim 1, characterised by a load sensor, designed to detect its total weight, including vegetation.

11. Container (1) according to claim 1, characterised in that it is designed as a longitudinally slit hose.

12. Container (1) according to claim 11, characterised in that it is designed to be connected to a skeleton in the form of an endoskeleton (32) or an exoskeleton (33).

13. Container (1) according to claim 12, characterised by a line provided and supported directly or indirectly thereon for supplying the plants with nutrient solution.

14. Container (1) according to any one of claims 11 to 13, characterised in that it is provided with a row of spaced-apart lip regions (35) at the separating slot (8), placed orthogonally in relation to the hose wall.

15. Container (1) according to claim 1, characterised in that it includes a grating (26), allowing the formation of a vegetation area, in particular one on which it is possible to walk, covering the interior of the container.

16. Container (1) according to claim 15, characterised in that a plurality of gratings (26) are arranged in planes which are parallel to one another.

17. Container (1) according to claim 15 or 16, characterised in that at least one textile mat (31) is arranged in a plane parallel to the grating arrangement.

18. Container (1) according to any one of claims 1 to 14, characterised in that it includes a basic container body (2) and a cover (3) having a non-segmented surface, the separating slot (8) being formed between the basic container body (2) and the cover (3).

19. Container (1) according to any one of claims 1 to 14, characterised in that at least one separating slot (8) is arranged within the cover (3).

20. Container (1) according to claim 19, characterised in that the cover (3) has a multiple part structure, composed of individual cover segments (10).

21. Container (1) according to claim 20, characterised in that the cover segments (10) are interconnected by hinges (13, 14).

22. Container (1) according to claim 20 or 21, characterised by a frame (11) encompassing the cover segments (10).

23. Container (1) according to claim 22, characterised in that the frame (11) is composed of a plurality of frame segments (15) interconnected by hinges (16).

24. Container (1) according to any one of claims 20 to 23, characterised in that two cover segments (10) are interconnected by a foil strip (44) folded at least once at minimal spaced-apart relationship of the cover segments (1).

25. Container (1) according to any one of claims 1 to 24, characterised by a foam strip (41) inserted into the separating slot (8).

26. Container (1) according to claim 25, characterised in that individual sections (42) of the foam strip (41) are connected to one another by a foldable strip (43).

27. Container (1) according to any one of claims 1 to 26, characterised by at least one spacer inserted into the separating slot (8).

28. Container (1) according to claim 27, characterised in that the spacer includes at least one passage aperture connecting the interior of the container to the exterior.

29. Container (1) according to any one of claims 1 to 28, characterised by lips (34) bounding the separating slot (8), and being orthogonally oriented in relation to adjacent container sections (2, 3, 10).

30. Container (1) according to any one of claims 1 to 29, characterised by a plurality of water-feed elements (40) arranged in the interior of the container.

31. Container (1) according to any one of claims 1 to 30, characterised in that it includes in each case at least one feed duct (4) and one discharge duct (5).

32. Container (1) according to any one of claims 1 to 31, characterised in that at least one container wall is formed by overlapping foil sections (20) permitting access from outside without the use of tools.

33. Container (1) according to any one of claims 1 to 32, characterised in that it includes an autonomous energy supply.

34. Container (1) according to any one of claims 1 to 33, characterised in that it includes at least one actuator element (30), selected from the group of actuator elements comprising an automatically operated valve, a pump, a mist generator, a sprinkler, an atomiser, a heating element and a cooling element.

35. Container (1) according to any one of claims 1 to 34, characterised by at least one sensor from the group of sensors comprising temperature sensors, humidity sensors, conductivity sensors and pH-sensors.

36. Process for supplying plant roots with nutrient solution without the use of soil having the following characteristics:
A container (1) is made available, designed to hold at least one plant while allowing it to grow,
Plant material is so placed into the container (1) that it can emerge through a container aperture providing a clamping effect, the said container aperture supporting at least one part of the plant in the course of the plant growth.

37. Process according to claim 36, characterised in that a separating strip (41) consisting of a porous, resilient material for the protection of the plant material is positioned in the container aperture.

38. Process according to claim 36 or 37, characterised in that a nutrient solution is atomised inside the container (1).

39. Process according to any one of claims 36 to 38, characterised in that processes being performed in the container (1) and/or detectable states are detected by sensors integrated in the container (1).

40. Process according to claim 39, characterised in that processes being performed in the container (1) are stored and statistically evaluated by a data processing system, wherein on the basis of such evaluation actuators (30), provided in the container (1), are controlled, in particular, remote-controlled and partially automated.
